(19) United States
(12) Patent Application Publication
(10) Pub. No.: US 2011/0060563 A1
(43) Pub. Date: Mar. 10, 2011

(54) Carbonaceous Chemistry for Continuum Modeling

(75) Inventors: Christopher Palmer Guenther, Morgantown, WV (US); Madhava Syamlal, Morgantown, WV (US)

(73) Assignee: United States Department of Energy, Washington, DC (US)

(21) Appl. No.: 12/663,944

(22) PCT Filed: Jun. 13, 2008
(86) PCT No.: PCT/US2008/066892

§ 371 Date: Dec. 10, 2009

Related U.S. Application Data
(60) Provisional application No. 60/943,581, filed on Jun. 13, 2007.

(51) Int. Cl. G06G 7/58; G06F 17/10; G06F 17/11

(52) U.S. Cl. 703/2

(57) ABSTRACT

A system and method of calculating fuel gasifier reactions is disclosed. The method and system model combustion/gasification within a gasifier by using an Eulerian-Eulerian flow field. The flow field is updated as the combustion/gasification progresses to account for the use of fuel as well as other reactions, mass transferred, and heat that occur within the gasifier during the combustion/gasification reactions.

### CROSS REFERENCE TO RELATED APPLICATIONS

This application claims the benefit of U.S. Provisional Application No. 60/943,581 filed on Jun. 13, 2007.

The United States Government has rights in this invention pursuant to Agreement between National Energy Technology Laboratory and the inventors and the employer-employee relationship of the U.S. Department of Energy and the inventors.

### BACKGROUND OF THE INVENTION

1. Field of the Invention

The present invention relates generally to a method for determining reaction rates within multiphase flow fields. More particularly the present invention relates to a method for determining the gasification and combustion reaction rates for any carbonaceous fuel (e.g. coal, biomass, oil shale, petcoke) in multiphase reactors.

2. Background of the Invention

Power plants of the future will use circulating fluidized bed (CFB) technology to gasify coal. Transport gasifiers will be a key component in the overall plant design of these future generation power plants, because they can operate at high throughput conditions, achieve better mixing and increase mass and heat transfer to ultimately achieve higher carbon conversion. Unfortunately, new reactor designs to improve performance, chemical conversion, reliability, and safety have been slow to emerge due primarily to the lack of understanding of the complex hydrodynamics and chemical interactions between the gas and solids phases.

Current approaches in designing new reactors generally incorporate a collection of empirical correlations and/or scaling laws using data from pilot-scale experiments. However, it is difficult to integrate this information into a comprehensive model and when large changes in scale or operating parameters occur, the use and accuracy of such an approach is questionable. As a result, the scale up to commercial-size gasifiers based on this design methodology is unreliable.

Algorithms for Eulerian-Eulerian gas-solid flow models have been proposed. Juray De Wilde et al. Journal of Computational Physics 207 (2005) 309-353. An Eulerian-Eulerian model of coal combustion also has been proposed. Fueyo et al. Proc. Annu. Int. Pittsburgh Coal Conf. 1995, 12, 1113-1118. However, these attempts lack detail related to chemical reactions, mass transfer and heat transfer.

Two-fluid or Eulerian-Eulerian hydrodynamic models have been attempted to describe fluidized beds. Very few Eulerian-Eulerian models exist to simulate gas-solids systems replete with chemical reactions and heat transfer.

A need exists in the art for a model that elucidates coal combustion/gasification reactions and rates. The model should simultaneously account for the surrounding flow field via application of an Eulerian-Eulerian model. Finally, such a model should enable the development of new reactor designs.

### SUMMARY OF INVENTION

An object of the invention is to completely model the combustion/gasification process within a gasifier of any size. A feature of the invention is that the invented system accounts for every species involved in the fuel combustion/gasification process. An advantage of the invention is that it elucidates reaction mechanisms and heat transfers based on the local hydrodynamics from an Eulerian-Eulerian model for salient reactions of the combustion/gasification of common fuels, including coal, petroleum, shale, and gas phase fuels.

An object of the present invention is to provide a system for calculating rates of reactions for a given carbonaceous fuel under any gas-solid process. A feature of the invention is that calculates rates of reaction for all active chemical reactions occurring within a combustion/gasification chamber. An advantage of the present system is that it allows for improved modeling of the conversion of a carbonaceous fuel (e.g. coal) during combustion and gasification.

Another object of the present invention is to provide a combustion/gasification reactor model that does not rely on direct observation of smaller scale reactions. A feature of the present invention is that it can be applied to a fluid-dynamic (gas-solid) analytical field of any size under any operating condition (e.g. pressure, temperature, and flow rates).

Yet another object of the present invention is to provide a coal combustion/gasification reaction model having broad utility. A feature of the invention is that its initialization step generates a table of variables for a plurality of carbon-based fuels. An advantage of the invention is that it elucidates the chemistry of the combustion/gasification process upon input of the name and/or type of the fuel and other environmental variables.

Another object of the present invention is to provide a means to simultaneously monitor carbonaceous fuels reactivity and the surrounding flow field. A feature of the present invention is that it calculates the reaction rates of both the gas and the solid phases of carbonaceous fuel (e.g. coal) combustion/gasification while maintaining the values of the surrounding flow field as generated by the Eulerian-Eulerian fluid dynamics model. An advantage of the invention is that it combines the fluid dynamics mapping of the Eulerian-Eulerian model with a consideration of the chemical reactions occurring within the gas phase and the solid phase.

The invention comprises a method for analyzing combustion/gasification systems, the method comprising: updating the cells of an Eulerian-Eulerian modeling field based on reactions associated with any carbonaceous fuel; determining stoichiometric coefficients of initial stage fuel combustion/gasification reactions; calculating specific heat, diffusivity, and conductivity values for gas and solids phase combustion/gasification products; allowing the Eulerian-Eulerian field to calculate a mass transfer coefficient; utilizing the mass transfer coefficient to generate data characteristics for the combustion/gasification system; upon calculating values for all cells within the Eulerian-Eulerian field, returning to the Eulerian-Eulerian model using the rate of formation and consumption of gas and solid species from the carbonaceous chemistry for continuum modeling to determine amount of mass transferred between the gas and solids phase; and iteratively repeating the above steps until continuity, momentum, transport and energy calculations are converged.

Also provided is a system for improving fuel combustion/gasification within a gasifier, the system comprising: means for processing input data regarding the gasifier geometry, fuel characteristics, pressure, temperature, flow rates, species concentrations, and boundary conditions; means for calculating the reactions within the gasifier, said means for calculating including a number of fluid-dynamics modeling fields; applying the modeling fields to calculate the rates of reactions, mass transferred, and heat of reaction within the gasifier; updating the modeling fields following the calculation of reaction rates; and iteratively repeating the above steps until continuity, momentum, transport, and energy equations of the system converge.

### BRIEF DESCRIPTION OF DRAWING

The invention together with the above and other objects and advantages will be best understood from the following detailed description of the preferred embodiment of the invention shown in the accompanying drawings, wherein:

FIGS. 1A and 1B depict computational models of the fluid flows within a gasifier charged with coal;

FIG. 2 is a flow chart describing the Eulerian-Eulerian model and its interaction with the module, in accordance with features of the present invention; and

FIG. 3 is a flow chart representing the Carbonaceous Chemistry for Continuum Modeling Module, in accordance with features of the present invention.

### DETAILED DESCRIPTION OF THE INVENTION

The invention is a method to couple the hydrodynamic behavior of a given reactor with the combustion/gasification chemistry of any carbonaceous fuel, the method comprising several steps. The first step involves producing or initializing of data stores for subsequent calculations. The initial calculations are due to devolatilization, moisture release, and tar cracking. The combustion/gasification calculations are the focus of subsequent steps.

Specifically, the present invention uses hydrodynamic data from an Eulerian-Eulerian model to elucidate reaction mechanisms for any carbonaceous fuel. An embodiment of the invention includes a means for receiving an input of gas and solids temperatures, gas pressures, gas and solids species mass fractions, voidage, solids volume fractions, gas density and viscosity, and gas and solids specific heats from an Eulerian-Eulerian model. Given this input, the module determines the heats of reactions, the rates of reactions related to coal gasification and combustion, and the mass transferred between the gas and solid phases. The invented system elucidates detailed reaction mechanisms coupled to the hydrodynamics from the Eulerian-Eulerian model.

An Eulerian-Eulerian model is a multiple fluid model (also known as a two fluid model designating two phases or components). Eulerian-Eulerian models treat the general case of modeling each phase (gas-solids) as a separate fluid with its own set of continuity and momentum and energy equations. In general each phase has its own velocity, temperature and pressure. Momentum between the phases is coupled through the drag and void fraction.

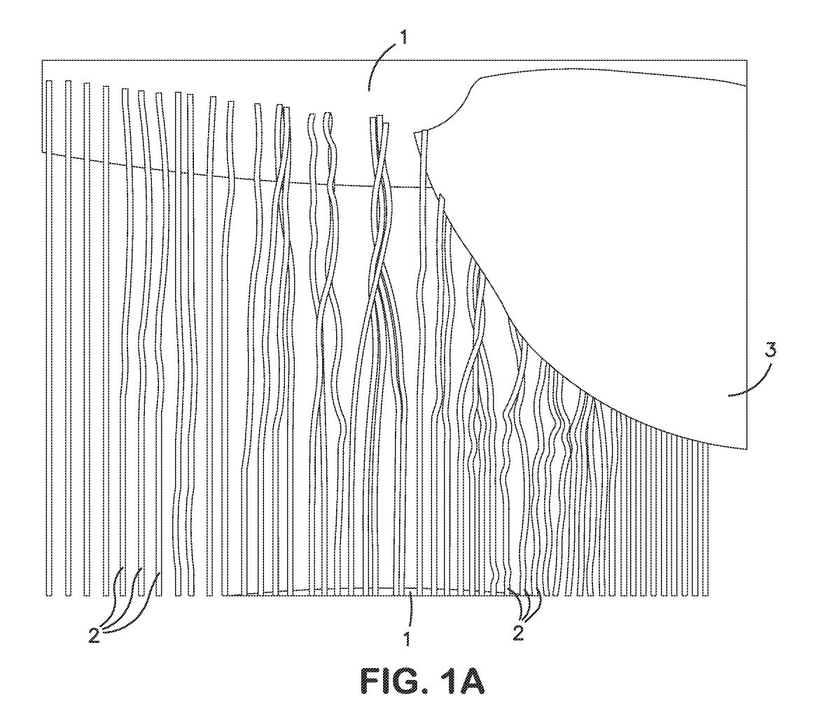

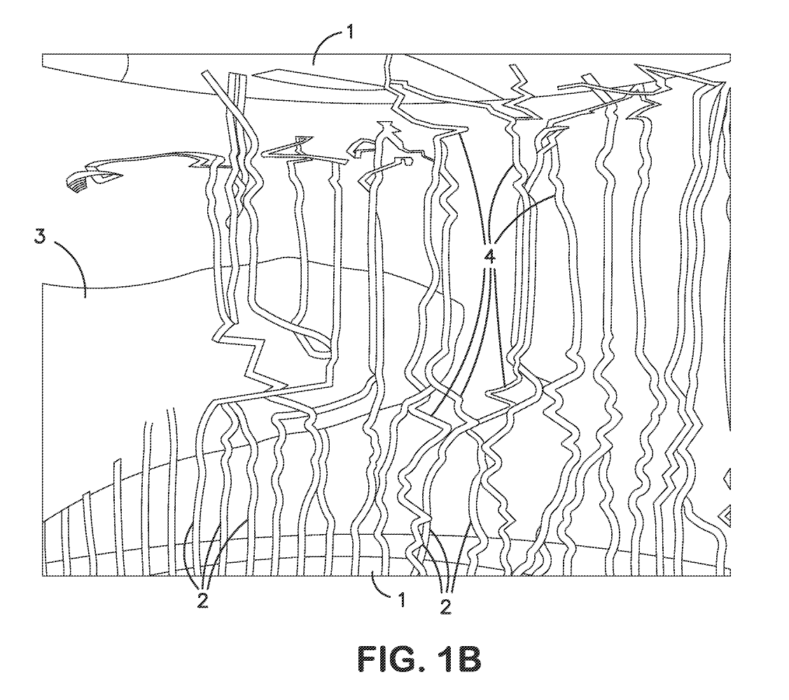

FIGS. 1A and 1B depict computational models of the fluid flows within a gasifier, 1, charged with coal 3. The fluid 2 comprises oxygen-containing fluids, including air, pure oxygen, carbon dioxide, nitrous oxides, sulfur oxides and other combustion related moieties. FIG. 1A shows a coal monolith 3 within the confines of the gasifier 1. The figure shows that despite the presence of the coal, fluid flow patterns within the gasifier are minimally disrupted. This results in poor coal penetration into the gasifier. Poor coal penetration leads to lower conversion of the coal, and therefore higher soot and carbon dioxide concentrations.

FIG. 1B depicts the interior of a gasifier wherein a complex flow pattern 4 exists. This complex pattern results in optimal mixing of the oxygenated fluid 2 (i.e. air) with the fuel. Optimal mixing leads to maximized contact between the fluid 2 and the fuel 3. The invented system, upon input of fluid types, fuel types, gasifier configurations, and reaction conditions (i.e. ambient temperature, reaction temperatures, fuel feed rates etc), predicts the fluid-flow characteristics engulfing the fuel and provides feedback to operators to optimize the combustion process.

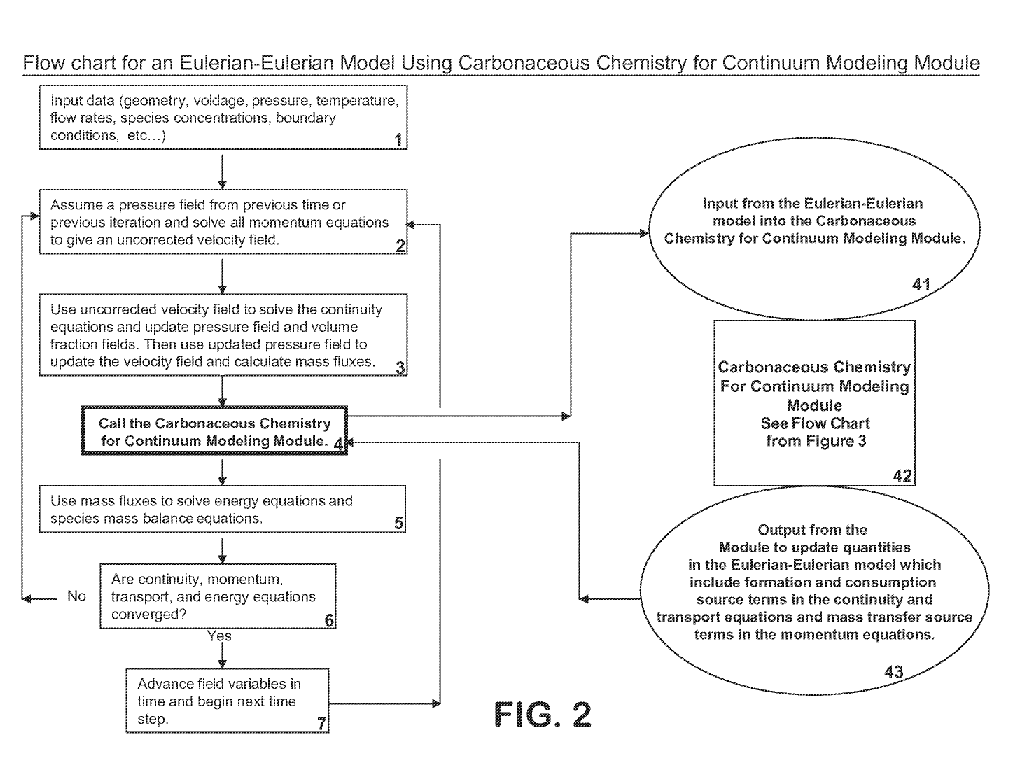

FIG. 2 shows a flow chart of an embodiment of the invented Eulerian-Eulerian process to update a flow field to arrive at a solution for the mass fraction distribution of each phase of coal combustion for a given time frame.

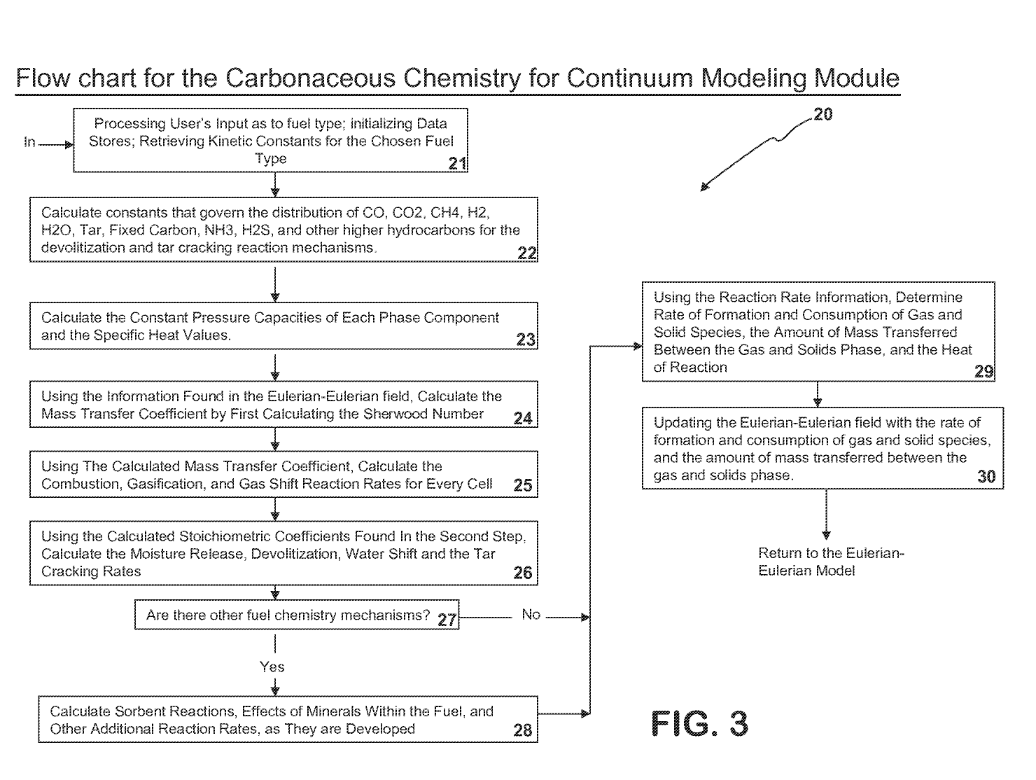

The diagram of FIG. 2 represents an Eulerian-Eulerian model for use with the instant protocol. The model interacts with the analysis module at point 4 utilizing a software program disclosed infra. FIG. 3 depicts the utilization of the Modeling Module upon input from the Eulerian-Eulerian protocol.

Element numbers 1-3 of the Eulerian-Eulerian model (FIG. 2) refer to calculations that can be done with an Eulerian-Eulerian multiphase model e.g., MFIX. The equations used in MFIX, can be found in the Summary of MFIX Equations, which is incorporated by reference in its entirety, herein, and reproduced in Appendix B. A manual, helpful in understanding the computer simulation for the coal gasifier is, C. Y. Wen et al., DOE/MC/16474-1390 (DE83009533), which is incorporated by reference in its entirety, herein.

The user provides input data (see step 1) on the gasifier to initiate the Eulerian-Eulerian model. 1. The input data includes the following parameters: geometry of the chamber, the voidage, the pressure, temperature, flow rates, fuel specie concentrations, boundary conditions and other input variables required by a predetermined Eulerian-Eulerian model. Upon receipt of the aforementioned data, the model then establishes a pressure field and solves momentum equations to calculate in step 2, an uncorrected velocity field for the contents of the gasifier. The calculations of step 2 are performed using the chosen Eulerian-Eulerian model, as described above.

Using the velocity field defined in step 2, the model then solves the continuity equations and updates the pressure field (initialized also in step 2) and volume fraction fields for each phase. These calculations occur in step three of the model (element number 3). The updated pressure field is used to calculate the velocity field and to calculate the mass fluxes.

The aforementioned calculated parameter for the updated velocity, pressure, and temperature fields are then passed to the Carbonaceous Chemistry for Continuum Modeling Module in step 4. The details of the operation of the Carbonaceous Chemistry for Continuum Modeling Module are described in FIG. 3. The module relies on input, 41, from the earlier steps (1-3) of the Eulerian-Eulerian model in its operations, 42. The output 43 from the module includes updated values of the Eulerian-Eulerian model, such as the formation and consumption of phase species. These values are used to update the continuity, transport, and momentum parameters initially established in step 2 of the Eulerian-Eulerian protocol.

Given the updated values from the Carbonaceous Chemistry for Continuum Modeling Module, the Eulerian-Eulerian model solves energy equations and the species mass balance equations in step 5. In a subsequent step 6, the model then evaluates the continuity, momentum, transport, and energy equations. If the equations have converged, the calculations for the time period under examination are concluded and the field variables are calculated, 7, for next time period. If convergence has not been reached, 6, the time period is not advanced. Instead, the calculations are run again by returning the pressure field to the earlier calculation step 2.

The Eulerian-Eulerian model continues to iterate until convergence of the equations is reached. In instances where convergence is not reached for a given time step, the calculations are repeated using a shorter time step. The length of the time step decreases until convergence is reached; otherwise, the calculation is suspended should the time step become outside of the bounds established by the Eulerian-Eulerian model. The selection of the time interval is a function of the Eulerian-Eulerian model. The invented module operates within the time step provided by the overall model; however, it is the Eulerian-Eulerian model that determines whether convergence, or a close approximation thereof, has been reached.

As depicted in FIGS. 2 and 3, the Carbonaceous Chemistry for Continuum Modeling Module logic operates when the Eulerian-Eulerian field has been initialized in the prior steps 1-3 depicted in FIG. 2. In some instances, the module is run on the same data set repeatedly, as indicated by the logic expressed in step 6 of FIG. 2. The details of the Carbonaceous Chemistry for Continuum Modeling module are found below.

One embodiment of the present invention relates to a method for modeling the reactions within multiphase flow.

### Step 1: Processing User's Input as to Coal Type; Initializing Data Stores; Retrieving Kinetic Constants for the Chosen Coal Type.

The first step 21 of the invented module 20 involves several substeps, the first of which is the definition of data stores for subsequent calculations.

During the initialization step 21, the module begins to interact with the Eulerian-Eulerian field which is initialized in step 21 as well as steps 1-3 in the process described in FIG. 2. In one embodiment, the Eulerian-Eulerian field comprises a fixed quantity of cells (represented as an array or matrix) and for each cell, certain values are already known, including:
1. The mass fraction of each fuel species found in the gaseous phase of the cell;
2. The mass fraction of each fuel species found in the solid phase of the cell;
3. The temperature of the gas phase of the cell;
4. The temperature of the solid phase of the cell;
5. The pressure of the gaseous and solid phases;
6. The void fraction;
7. The gas phase and the solid phase velocity; and
8. The granular energy.

Each cell within the Eulerian-Eulerian flow field stores its own set of these values, essentially retaining preferably these eight values in for each cell within the field. Furthermore, most of the values described above are not simple integers, but in fact can be complex structures storing several different numbers. For example, the mass fraction of each gaseous phase species (value 1 above), would comprise a set of numbers, each number representing the percentage of a different gas specie, such as 0.05 for CO or 0.009 for CO₂. The methods of storing such complex data structures are well-known in the art and can be accomplished through multi-dimensional arrays, structs, or the like.

The overall purpose of the invented system is to use the changes of the temperature, pressure, velocity in each cell of the model in the determination of the gas-solid reaction rates. As such, the module determines reaction rates as each cell described in the Eulerian-Eulerian model, and the resulting updated field contains a complete flow regime map of the gasifier.

### Definition of Data Stores

As part of the first step 21, data stores for data relating to devolatilization reactions are also defined. The devolatilization data variables includes variables storing tar combustion parameters (FTC, FTH, FTO, FTN, FTS in one embodiment), carbon monoxide (DOCO), carbon dioxide (DOCO2), and water contents (DOH2O), and the quantities of reactants available during the devolatilization reactions (DHH2, DHCH4, DHC2H6, DHC2H4, DHC3H8, DHC6H6, COCO, COC2, COH2O). These variables are both defined and initialized using known values for each parameter. The source of the values includes experimental data and published articles such as Syamlal, M. and L. A. Bissett, “METC Gasifier Advanced Simulation (MGAS) Model,” Technical Note, DOE/METC-92/4108, NTIS/DE92001111, National Technical Information Service, Springfield, Va. (1992).

As part of the initialization step, 21, data stores for subsequent reactions and processes are defined. For example, stoichiometric coefficients for the devolatilization process, stoichiometric coefficients in the tar cracking reaction, the heat of the tar combustion reaction, and the cracking coefficients, are determined.

The initialization process of step 21 then defines common variables for subsequent calculations, and a number of common containers for the variables. In one embodiment these are:
Proximate analysis variables: PAFC (fixed carbon), PAVM (volatile matter), PAA (ash content), PAM (moisture content)
Ultimate analysis variables: UAC (carbon amount), UAH (hydrogen amount), UAO (oxygen amount), UAN (nitrogen amount), UAS (sulfur amount)
Higher heating value of coal: HHVC
Higher heating value of tar: HHVT
Name of Coal: sCoalNam

### Definition of Constants Based on User Input

The initialization step 21 also defines a number of constants, including the kinetic constants for various types of coal. The system includes information about the contents of commercially available coal feed stocks including but not limited to Pittsburgh No. 8 coal, Arkwright Pittsburgh, Illinois No. 6, Rosebud and North Dakota Lignite. In one embodiment, the user (either interactively or through automated means), selects the type of coal being analyzed; however, automated methods of detecting coal type are contemplated. The system stores rate constants (e.g. activation energies) for the coal specified. In one embodiment, each coal data variable is an array containing five fields, but the size is merely dependant on the number of fuel types considered. It should be appreciated that other fuel types can be included in the analysis, once the relevant physical properties are documented.

In one embodiment, the variables containing coal information are called SAK2(5), SAE2(5), SAK5(5), SAE5(5), SAKM(5), SAEM(5), SAKD(5), SAED(5), SAKC(5), SAEC(5), SWG3(5). In one embodiment, the SAK constants are part of the pre-exponential factors used in the reaction rates and the SAE constants are part of the activation energy in the reaction rates

With the definition of the variables complete, basic error checking is done on the user-provided coal type entry, along with the remaining variables which the user provided. Additional error checking verifies the variables which store relative percentages of each type of component of the fuel. The sum of PAFC, PAVM, PAM, PAA should be 1 and the sum of UAC, UAH, UAO, UAN, UAS, PAM, and PAA should also be 1. Given that these variables store percentage contents of the fuel, if a sum is not equal to 1 indicates that some of the fuel contents are not accounted for. This error checking ensures that all components of the fuel are being considered.

Upon successful completion of the error checking, the initialization step 21 retrieves the column of data from a table of kinetic constants for the type of coal the user had selected. In one embodiment of the invention, the kinetic constant variables are stored in analogous names as the coal type variables, except without the leading letter S in the name (i.e. SAK2 is stored in AK2).

### Initial Calculations

The final phase of the initialization step 21 involves a number of brief calculations. The density of dry, ash-free coal is calculated as the sum of the fixed carbon amount (PAFC) and volatile matter amount (PAVM), multiplied by the density of the particle (RO_s(1)). The calculation presumes a constant density for the coal sample. The calculation is stored in DAFC. In one embodiment, the variable calculation is as follows:

DAFC=RO_{—}s(1)*(PAFC+PAVM)

Finally, the system calculates the void fraction of the ash layer, (stored in EP_A, per one embodiment):

EP_A=0.25+0.75*(1−ash content).

Further, the square of the ash layer is also calculated and stored in the variable f_EP_A, in one embodiment.

At this point, the initialization step 21 is complete and the invented process moves to setting the constants for the devolatilization reaction.

### Step 2: Defining and Initializing Variables Needed to Determine the Stoichiometric Coefficients of Initial Stage Reactions in Devolitization and Tar Cracking;

Stoichiometric constants that govern the distribution of CO, CO₂, CH₄, H₂, H₂O, Tar, Fixed Carbon, NH₃, H₂S and other higher hydrocarbons for the devolitization and tar cracking reactions are calculated as part of the coefficient calculation step 22. The equations used to calculate these values are listed in the report by Syamlal and Bisset DOE/METC-92/4108(DE92001111), (“Syamlal”) Incorporated in its entirety by reference herein.

The calculation of the constants as part of step 22 requires a series of preliminary calculations. As part of preliminary environmental calculations, the tar cracking constants are derived, along with the variables relating to the composition of the volatile matter and the tar fraction and the char fraction.

### Preliminary Environmental

### Detail Calculations

First, constants for the tar cracking reaction are calculated. The calculations are based on the molecular weight of tar (stored as MW_g(8) in one embodiment). These include the amount of oxygen gas involved (F3_{—}1), the amount of resulting carbon dioxide (F3_{—}3) and the amount of resulting water (F3_{—}6). As part of the calculations, the heat for the cracking reaction is derived. Finally, the amount of heat released by the tar cracking reaction is also calculated and stored (in HEATF3, for example). The specific calculations involved in this stage are:

F3_{—}1=MW_{—}g(8)*(FTC/12.+FTH/4.−FTO/32.)

F3_{—}3=MW_{—}g(8)*FTC/12.

F3_{—}6=MW_{—}g(8)*FTH/2.

HEATF3=MW_{—}g(8)*((FTC/12.)*(−94052.)+(FTH/2.)*(−57798.))

Second, the composition of the volatile matter is calculated. Preliminarily, the total amount of matter and the amount of volatile matter is calculated and as such, the amount of change of the amount of fixed carbon content is calculated. Next, the amounts of carbon, hydrogen, oxygen, nitrogen, and sulfur in the volatile matter is updated. While extension into this type of coal is possible, some embodiments of the invented module do not process coal containing nitrogen or sulfur, and so an error results if either one is detected in the calculations.

Other embodiments of the invention are capable of processing nitrogen, sulfur, and other additional species found in the coal. The invented module is general in that any fuel component, such as ammonia or H₂S may be handled by the model, however the embodiment must be able to include the reactions and enter the amount of nitrogen and sulfur as input in the ultimate analysis steps described below.

Next, the calculation step 22 determines the tar fraction in the devolatilization reaction. The tar fraction is calculated using the following formula (spanning multiple lines):

$$ALPHAD = ( 42 * DHCH 4 + 168 * DHC 6 H 6 + 63 * DHC 3 H 8 + 56 * DHC 2 H 6 + 84 * DHC 2 H 4 ) * FVS + ( ( 84 * DHCH 4 + 336 * DHC 6 H 6 + 126 * DHC 3 H 8 + 112 * DHC 2 H 6 + 168 * DHC 2 H 4 ) * DOH 2 O - 84 * DOCO 2 - 168 * DOCO ) * FVO + ( 144 * DHCH 4 + 576 * DHCH 6 H 6 + 216 * DHC 3 H 8 + 192 * DHC 2 H 6 + 288 * DHC 2 H 4 ) * FVN + ( - 672 * DHCH 4 - 2688 * DHC 6 H 6 - 1008 * DHC 3 H 8 - 896 * DHC 2 H 6 - 1344 * DHC 2 H 4 ) * FVH + 224 * FVC ) / ( ( 42 * DHCH 4 + 168 * DHC 3 H 8 + 6 * DHC 2 H 6 + 84 * DHC 2 H 4 ) * FTS + ( ( 84 * DHCH 4 + 336 * DHC 6 H 6 + 126 * DHC 3 H 8 + 112 * DHC 2 H 6 + 168 * DHC 2 H 4 ) * DOH 2 O - 84 * DOCO 2 - 168 * DOCO ) * FTO + ( 144 * DHCH 4 + 576 * DHC 6 H 6 + 216 * DHC 3 H 8 + 192 * DCH 2 H 6 + 288 * DHC 2 H 4 ) * FTN + ( - 672 * DHCH 4 - 2688 * DHC 6 H 6 - 1008 * DHC 3 H 8 - 896 * DHC 2 H 6 - 1344 * DHC 2 H 4 ) * FTH + 224 * FTC$$

The above variables, representing constituent parts of the coal, were initialized as part of the initialization step 21. Whereas in some embodiments of the invention, the module does not reach this point if sulfur or nitrogen is present, several variables relating to sulfur and nitrogen must be set to zero (mainly FVS, FVN), thereby simplifying the calculation.

The resulting value from this formula is the tar fraction in the devolatilization reaction (stored in variable, AlphaD, in one embodiment of the invention). This value is used in the subsequent calculation in the current step 22.

Next, the char fraction needed for the subsequent cracking reaction is calculated using the following formula:

$$ALPHAC = FTC - ( FTH - FTS * 2 / 32 - FTN * 3 / 14 - FTO * COH 2 O * 2 / 16 ) * ( CH CH 4 * 12 / 4 + CH C 2 H 6 * 24 / 6 + CH C 2 H 4 * 24 / 4 + CH C 3 H 8 * 36 / 8 + CH C 6 H 6 * 72 / 6 ) - FTO * ( CO CO * 12 / 16 + CO CO 2 * 12 / 32 )$$

The variables involved in this second calculation are also initialized as part of the first step 21. The char fraction must be a positive, non-zero number, in order for the process to continue.

### Hydrogen Availability Verification

In some embodiments of the invention, the fuel within the gasifier includes Nitrogen and Sulfur. Reactions involving these two components rely on Hydrogen to be present within the system. Subsequently, the calculation step 22, in some embodiments of the invention, determines the amount of hydrogen used in several reactions. Specifically, Hydrogen is consumed in formation of hydrogen sulfide, ammonia, and water. The amount consumed at each step is calculated separately:

H1=(FVS−AlphaD*FTS)*2/32(formation of hydrogen sulfide)

H2=(FVN−AlphaD*FTN)*3/14(formation of ammonia)

H3=(FVO−AlpahD*FTO)*DOH2O*2/16(formation of water)

If any of these three calculations net a negative number, then the amount of hydrogen in the system is insufficient.

Next, the amount of remaining hydrogen is calculated. It is based on the amount of hydrogen in the volatile matter, along with the amounts used to form the three devolatilization byproducts discussed above. As such, the remaining hydrogen is calculated as:

H4=FVH−AlphaD*FTH−H1−H2−H3.

Next the amount of hydrogen used for the formation of hydrogen containing species is calculated as well:

H5=FTS*2/32(formation of hydrogen sulfide)

H6=FTN*3/14(formation of ammonia)

H7=FTO*COH2O*2/16(water formation)

Following the calculation of the amount of hydrogen used for the hydrogen containing species, the amount of remaining hydrogen is again calculated. Following this second hydrogen-use step, the amount of hydrogen remaining is:

H8=FTH−H5−H6−H7

An error is generated or logged if an insufficient amount of hydrogen had been available as part of this process.

### Devolitilization Calculations

### Detail

At the conclusion of these calculations, the calculation step 22 has generated all values necessary for the coefficients for devolatilization reaction to be calculated. A coefficient is calculated for each devolatilization product, such as carbon monoxide, carbon dioxide, and others. In one embodiment of the invention, the coefficients are stored in an array-type structure, but other means of storage of these values, is foreseen. The coefficients are calculated accordingly:

BETAD(2)=(FVO−ALPHAD*FTO)*DOCO*28/16(carbon monoxide)

BETAD(3)=(FVO−ALPHAD*FTO)*DOCO2*44/32(carbon dioxide)

BETAD(4)=H4*DHCH4*16/4(methane)

BETAD(11)=H4*DHC2H4*28/4(ethylene)

BETAD(12)=H4*DHC2H6*30/6(ethane)

BETAD(13)=H4*DHC3H8*44/8(propane)

BETAD(14)=H4*DHC6H6*78/6(benzene)

BETAD(5)=H4*DHH2(molecular hydrogen—H₂)

BETAD(6)=H3*18/2(water)

BETAD(7)=H1*34/2(hydrogen sulfide)

BETAD(9)=H2*17/3(ammonia)

Again, in one embodiment of the invention, each of the coefficients is assigned to a fixed location within an array (called BetaD in the embodiment), but other means of storing the coefficients are foreseen.

Analogously, the coefficients for the tar cracking reaction are calculated and stored in another array structure. The calculation for each coefficient is reflected below:

BETAC(2)=FTO*COCO*28/16(carbon monoxide)

BETAC(3)=FTO*COCO2*44/32(carbon dioxide)

BETAC(4)=H8*CHCH4*16/4(methane)

BETAC(11)=H8*CHC2H4*28/4(ethylene)

BETAC(12)=H8*CHC2H6*30/6(ethane)

BETAC(13)=H8*CHC3H8*44/8(propane)

BETAC(14)=H8*CHC6H6*78/6(benzene)

BETAC(5)=H8*CHH2(molecular hydrogen—H₂)

BETAC(6)=H7*18/2(water)

BETAC(7)=H5*34/2(hydrogen sulfide)

BETAC(9)=H6*17/3(ammonia)

Prior to calculating the amount of heat generated as part of the reaction, the calculation step 22 can optionally calculate the heating value of the coal and tar, using the Dulong formula, as shown in the calculations herein. The DuLong formula is implemented in the calculations below (i.e. it is explicitly given in usr0.f) and is known within the art.

The calculation of the heating value of coal factors the percentage amounts of carbon (UAC), hydrogen (UAH), oxygen (UAO) and sulfur (UAS) within the coal which were initialized in step 21. In one embodiment, the final amount is stored in a variable called HHVC. The amount is calculated as:

HHVC=8080*UAC+34444.4*(UAH−UAO/8.)+2277.8*UAS

The calculation of the heating value of tar relies on analogous variables, except that these store the relative contents of tar. Specifically, the calculation is:

HHVT=8080.*FTC+34444.4*(FTH−FTO/8.)+2277.8*FTS

Using the previously-calculated stoichiometric coefficients along with the heating values of coal and tar, the amount of heat generated from both the devolatilization reaction and the tar cracking reaction can be calculated. For the calculation of the heat of the devolatilization reaction, the units returned are calories per gram of volatile matter (cal/g-VM). In one embodiment, the heat of devolatilization is stored in a variable called HeatD and is calculated as:

$$HEAT D = ( - HHVC - PAVM * ( ( - HHVT ) * ALPHA D + ( - 2415.6 ) * BETA D ( 2 ) + ( - 13300.0 ) * BETA D ( 4 ) + ( - 12043.9 ) * BETA D ( 11 ) + ( - 12427.3 ) * BETA D ( 12 ) + ( - 12059.1 ) * BETA D ( 13 ) + ( - 10012.6 ) * BETA D ( 14 ) + ( - 34158.5 ) * BETA D ( 5 ) + ( - 584.4 ) * BETA D ( 6 ) + ( - 3956.5 ) * BETA D ( 7 ) + ( - 5394.2 ) * BETA D ( 9 ) ) - PAFC * ( - 7837.7 ) ) / PAVM$$

The variables involved in the calculation include the proximate analysis variables discussed in the initialization step 21 of the process (i.e. PAFC for fixed carbon content, PAVM for volatile matter content, PAA for ash content, and PAM for moisture content), the stoichiometric variables calculated earlier in this step 22 (BetaD₂ . . . . BetaD₁₄), the heating values of coal and tar (HHVT and HHVC), and the tar fraction (AlphaD).

Analogously, the heat of the tar cracking reaction is calculated as part of this process step. Per one embodiment, the calculation result is stored in a variable called HeatC, and is calculated as:

$$HEAT C = - HHVT - ( ( - 7837.7 ) * ALPHA C + ( - 2415.6 ) * BETA C ( 2 ) + ( - 13300.0 ) * BETA C ( 4 ) + ( - 12043.9 ) * BETA C ( 11 ) + ( - 12427.3 ) * BETA C ( 12 ) + ( - 12059.1 ) * BETA C ( 13 ) + ( - 10012.6 ) * BETA C ( 14 ) + ( - 34158.5 ) * BETA C ( 5 ) + ( - 584.4 ) * BETA C ( 6 ) + ( - 3956.5 ) * BETA C ( 7 ) + ( - 5394.2 ) * BETA C ( 9 ) )$$

The variables involved in this calculation include the heat heating value of tar (HHVT), the tar cracking coefficients (BetaC₂ . . . . BetaC₁₄) and the char fraction amount (AlphaC). The amount calculated is measured in calories per gram of tar (cal/g-Tar).

### Step 3: Calculating the Constant Pressure Capacities of Each Phase Component and the Specific Heat Values;

The initialization step 21 and the coefficient calculation step 22 facilitate the subsequent calculations within the system. A subsequent step, 23, provides some of the substantive calculations, such as calculating the constant pressure capacities, as used by the invented system.

These calculations utilize input temperatures calculated during the prior steps 21 and 22 as well as within the Eulerian-Eulerian model described in FIG. 2. Input temperatures are used to calculate the specific heats of the system, the thermal diffusivity, and conductivity values over time for both the solid and gas phases.

The calculations involved in deriving the specific heat values of the system require several precursor calculations to occur. Once constant pressure capacities of each phase component are known, it is possible to calculate the specific heat values for each cell that is modeled by the Eulerian-Eulerian field, including the gas phase and the solid phase. Specific heat values, also derived at the present step, 23, are used for the subsequent calculations.

### Constant Pressure Capacities

### Storage Detail of Phase Components

Constant pressure heat capacities for each coal component and other reactant are then stored. For illustrative purposes herein, the heat capacities are stored in variables starting with the letters “CP,” and include the heat capacities of dioxygen, carbon-monoxide, carbon dioxide, methane, dihydrogen, water, hydrogen sulfide, dinitrogen, ammonia, tar, ethylene, ethane, propane, benzene, volatile matter, ash, fixed carbon, and the specific heat of the moisture content of the coal.

The constant pressure heat capacities for each of the above-mentioned reactants or coal components are calculated depending on the location where the heat capacity is evaluated. A separate calculation occurs for each component or reactant. Preferably, the outcome of the calculation is determined by the temperature parameter provided to the calculating function. In one embodiment, the temperature parameter that is provided is called XXX. The solution of each constant-pressure heat capacity function is only performed once the input parameter has been calculated. As such, for a given parameter XXX, the heat capacity is calculated as follows:

dioxygen—CPO2(XXX)=(8.27+0.000258*XXX−187700.0/XXX**2)/32.

carbon-monoxide—CPCO(XXX)=(6.6+0.0012*XXX)/28.

carbon dioxide—CPCO2(XXX)=(10.34+0.00274*XXX−195500.0/XXX**2)/44.

methane—CPCH4(XXX)=(5.34+0.0115*XXX)/16.

dihydrogen—CPH2(XXX)=(6.62+0.00081*XXX)/2.

water—CPH2O(XXX)=(8.22+0.00015*XXX+0.00000134*XXX**2)/18.

hydrogen sulfide—CPH2S(XXX)=(7.2+0.0036*XXX)/34.

dinitrogen—CPN2(XXX)=(6.5+0.001*XXX)/28.

ammonia—CPNH3(XXX)=(6.7+0.0063*XXX)/17.

tar—CPTAR(XXX)=0.45

ethylene—CPC2H4(XXX)=(2.83+28.6E−3*XXX−8.726E−6*XXX**2)/28.

ethane—CPC2H6(XXX)=(2.247+38.2E−3*XXX−11.05E−6*XXX**2)/30.

propane—CPC3H8(XXX)=(2.41+57.2E−3*XXX−17.53E−6*XXX**2)/44.

benzene—CPC6H6(XXX)=(−0.409+77.62E−3*XXX−26.4E−6*XXX**2)/78.

fixed carbon—CPFC(XXX)=−0.1315+1.341E−3*XXX−1.087E−6*XXX*XXX+3.06E−10*XXX*XXX*XXX

volatile matter—CPVM(XXX)=0.1743+8.1E−4*XXX

ash—CPA(XXX)=0.1442+1.4E−4*XXX

heat of the moisture content of the coal—CPM(XXX)=1.00763

The constants used in the calculations above and in the heat capacities of the reactants were either described in the literature or were determined experimentally. Additional constant pressure heat capacity functions can be established, in the event that further reactants need to be considered by the system.

### Constant Pressure Specific Heat of Air Calculation

Next, as part of the current step 23 in the calculation process, the properties of the gas phase are analyzed and re-calculated over each cell of the Eulerian-Eulerian flow field. The analysis begins at a three-dimensional position, in general, at coordinates ijkStart and ends at another set of coordinates ijkEnd. In order to arrive at the specific heat of gas phase in the Eulerian-Eulerian model, the density of the selected cell is first calculated. The density is calculated by summing the result of the division of the mass fraction of each of the species found within the cell with the molecular weight of each of the contents found within the cell. In one embodiment this calculation is stored in a variable called MW, and the value is calculated as:

MW=MW+SUM(X_G(IJK,:NMAX(0))/MW_G(:NMAX(0)))

Where X_G contains the mass fraction of each species found in the cell and MW_G contains the molecular weight of the species found in the cell. At the end of this calculation MW will contain the average molecular weight of the cell. This value is stored in an array for the cell as well as to the Eulerian-Eulerian field representing this cell.

Following the calculation of the density of the cell, the constant pressure specific heat of the Eulerian-Eulerian gas phase can be calculated. Again, this value is calculated for each of the cells.

In one embodiment, the value is stored in an array, and the array is called C_pg. The constant pressure capacity values that were defined above (such as CPO2 and others) are used as part of this calculation in step 23. The pressure of the gas phase is determined by the temperature of the cell, and this information is obtained from the Eulerian-Eulerian field, which contains the temperatures of the gas and solid phases of each cells within the field. In one embodiment, the temperature within the field is stored in a variable called TGX.

The mass fraction of each species within the cell is stored in an indexed array wherein each cell of the array represents the mass fraction of a different species. The gas species index number is as follows:

TABLE 1
Index Numbers of Gas Specie

| | Index Number | | | | | | | |
|---|---|---|---|---|---|---|---|---|
| | 1 | 2 | 3 | 4 | 5 | 6 | 7 | 8 |
| Gas | O₂ | CO | CO₂ | CH₄ | H₂ | H₂O | N₂ | Tar |
| Species | | | | | | | | |

Analogously, the solid species are references by the following index structure:

TABLE 2
Index Numbers of Solid Specie

| | Index Number | | | | | | | |
|---|---|---|---|---|---|---|---|---|
| | 1 | 2 | 3 | 4 | 5 | 6 | 7 | 8 |
| Solid species | Fixed | Volatile | Moisture | Ash | CaCO₃ | CaMg(CO₃)₂ | CaO | MgO |
| | Carbon | Matter | Content | | | | | |

In one embodiment of the invention, X_g is the array storing the mass fraction of the gas phase while X_s is the array storing the mass fraction of the solid phase. As such, X_g(IJK,3) will contain the mass fraction of CO₂ in cell number IJK, for example.

The constant pressure specific heat of the gas is therefore calculated as part of step 23 using the following calculation:

$$C\_pg ( IJK ) = X\_g ( IJK , 1 ) * CPO 2 ( TGX ) + X\_g ( IJK , 2 ) * CPCO ( TGX ) + X\_g ( IJK , 3 ) * CPCO 2 ( TGX ) + X\_g ( IJK , 4 ) * CPCH 4 ( TGX ) + X\_g ( IJK , 5 ) * CPH 2 ( TGX ) + X\_g ( IJK , 6 ) * CPH 2 O ( TGX ) + X\_g ( IJK , 7 ) * CPN 2 ( TGX ) + X\_G ( IJK , 8 ) * CPTAR ( TGX )$$

### Specific Heat Calculation

### Detail of Each Solid Phase

Next, the specific heat of the specie within each solid phase is calculated as part of the Constant Pressure Capacities calculation step 23. It is foreseen that multiple solid phases will exist within the solid matter under analysis. However, the same process can be reiterated regardless of the number of solid phase subgroups involved, even if there is only set of solid phase species.

The process is repeated for every cell within the Eulerian-Eulerian model selected for analysis. The temperature of the solid species is determined from the Eulerian-Eulerian model and stored in a variable, TSX, in one embodiment of the invention. If more than one solid phase group is involved, an index variable, such as M in some embodiments, can be used to store the number of solid phase.

The calculation of specific heat of the solid takes into account the mass fraction of each species along with the constant pressure heat capacities functions for the solids as defined in the step above. The calculation proceeds as follows:

$$C\_ps ( IJK , M ) = X\_s ( IJK , M , 1 ) * CPFC ( TSX ) + X\_s ( IJK , M , 2 ) * CPVM ( TSX ) + X\_s ( IJK , M , 3 ) * CPM ( TSX ) + X\_s ( IJK , M , 4 ) * CPA ( TSX ) + ( X\_s ( IJK , M , 5 ) + X\_s ( IJK , M , 6 ) + X\_s ( IJK , M , 7 ) + X\_s ( IJK , M , 8 ) ) * CPA ( TSX )$$

Where X_s represents the mass fraction of each species, and each of the CPx functions are as defined above.

### Dry Ash Calculation

The next intermediate calculation provides the amount of the dry ash, which is free carbon in the coal volatile matter. This calculation is performed now at the conclusion of step 23 and the value derived will be used in the devolitization reaction. The calculation occurs at this step, inasmuch as it relies on the temperature parameter, TSX, which is used for the earlier calculations in step 23, as well as other calculations previously performed in preparation for step 23.

In one embodiment, the calculation first calculates a temporary variable VMLeft using the present temperature of the solid phase along with constants from Coal Conversion Systems Technical Data Book (1978), p. 17, whose contents are incorporated herein by reference. That calculation is:

VMLEFT=((867.2/(TSX−273.))**3.914)/100.

Finally the VMStar value for the cell is arrived at by multiplying density of dry, ash-free coal, stored in DAFC with the intermediate value described above. The value is stored in an array for the particular cell being examined:

VMSTAR(IJK)=DAFC*VMLEFT

If there was no volatile matter found in this cell, or if the temperature was less than 1233.0 degrees Kelvin, the VMSTAR value for the cell would be set to zero.

### Mass Transfer Coefficient

### Calculation Detail

Using the information found in the Eulerian-Eulerian field, the mass transfer coefficient is calculated by first calculating the Sherwood Number.

The mass transfer coefficient which governs the amount of mass being released from the solids phase into the gas phase is then calculated, step 24. This step uses the voidage, gas pressure, local gas and solids velocities, gas viscosity, and gas temperature from the EE model to calculate the mass transfer coefficient based on the work by Gunn, which is incorporated in its entirety by reference herein (Gunn, D. J., 1978, “Transfer of Heat or Mass to Particles in Fixed and Fluidized Beds,” Int. J. Heat Mass Transfer, 21, 467-476). In one preferred embodiment of the present invention, the physical_prop.f subroutine is used to perform the Mass Transfer Coefficient calculation step 24. The source code below is the relevant portion of the file associated with this step.

The Mass Transfer Calculation Step 24 requires a preliminary determination. First, the Sherwood number for the solids phases is calculated and stored. The Sherwood Number (Sh) is a dimensionless number used in mass transfer operations. It represents the ratio of convective to diffusive mass transport. It is defined as follows:

Sh=KₘL_{C}/D

Where L_{C}=characteristic length scale; D=diffusivity, and K=mass transfer coefficient.

In one embodiment, the Sherwood number (and its square) is calculated using a formula that factors the temperature of the gas at the cell, the pressure of the gas found in the cell, and the other Eulerian-Eulerian field components described in step 21 above.

The calculation of the Sherwood Number is represented by the following series of calculations:

EP_{—}g2=EP_{—}g(IJK)*EP_{—}g(IJK)

DIFF=4.26*((T_{—}g(IJK)/1800.)**1.75)*1013000./P_{—}g(IJK)

Sc1o3=(MU_{—}g(IJK)/(RO_{—}g(IJK)*DIFF))**(1./3.)

The calculation depends on values from the Eulerian-Eularian field described above.

IMJK=IM_OF(IJK)

IJMK=JM_OF(IJK)

IJKM=KM_OF(IJK)

I=I_OF(IJK)

UGC=AVG_X_E(U_{—}g(IMJK),U_{—}g(IJK),I)

VGC=AVG_Y_N(V_{—}g(IJMK),V_{—}g(IJK))

WGC=AVG_Z_T(W_{—}g(IJKM),W_{—}g(IJK))

USCM=AVG_X_E(U_{—}s(IMJK,M),U_{—}s(IJK,M),I)

VSCM=AVG_Y_N(V_{—}s(IJMK,M),V_{—}s(IJK,M))

WSCM=AVG_Z_T(W_{—}s(IJKM,M),W_{—}s(IJK,M))

VREL=SQRT((UGC−USCM)**2+(VGC−VSCM)**2&+(WGC−WSCM)**2)

In the calculation above, U,V, and W are the velocity of either the solid or gas components.

In one embodiment, the section of source code for the Mass Transfer calculation step 24, also calculates the amount of volatile matter remaining in the solid phase based on constants taken from Coal Conversions Systems Technical Data Book, Institute of Gas Technology, Chicago, Ill., 1978, page 17, incorporated herein by reference. The source code associated with calculating the amount of volatile matter remaining is:

VMLEFT=((867.2/(TSX−273.))**3.914)/110

The Mass Transfer calculation step 24 keeps track of the amount of volatile matter remaining inasmuch as the volatile matter provides the gasification system with a source of combustible material and energy.

Once the above-listed values are calculated, it is possible to calculate the mass transfer coefficient. It is stored in an array in a cell representing the cell being examined. In one embodiment, the mass transfer coefficient is calculated as:

$$N\_sh ( IJK , M ) = ( ( 7. - 10. * EP\_g ( IJK ) + 5. * EP\_g 2 ) * ( ONE + 0.7 * Re ** 0.2 * Sc 1 o 3 ) + ( 1.33 - 2.4 * EP\_g ( IJK ) + 1.2 * EP\_g 2 ) * Re ** 0.7 * Sc 1 o 3 )$$

As for other steps disclosed in the system, the calculations of the present step 24 are repeated for every cell within the Eulerian-Eulerian field.

### Step 5: Using the Calculated Mass Transfer Coefficient, Calculate the Combustion, Gasification, and Gas Shift Reaction Rates for Every Cell;

Using the mass transfer coefficient values calculated in step 24, and the combustion rates, devolitization rates, gasification rates, tar cracking rates, and water gas shift reaction rates are determined, 25. The calculations rely on a number of previously-determined values. For example, the species concentration (as provided by the user in step 1 depicted in FIG. 2), and the temperature values takes from the Eulerian-Eulerian modeling field are used to calculate the rates of combustion/gasification and related information.

In one preferred embodiment of the present invention, subroutine rrates.f, reproduced in Appendix C, and the gas and solids temperature, gas pressure, voidage of the gas and solid phase and the species mass fractions from the Eulerian-Eulerian model are used to calculate these values.

### Combustion Rates

### Calculation Detail

The combustion reaction rates are calculated first and these reactions correspond to equations 3.1-3.5 in the Coal Chemistry document in Appendix A. The combustion reaction rates are based in part on information found in the open literature. In general, the framework of an exemplary model (e.g. the “shrinking core model”) relies on the Sherwood Number, as elucidated in the Mass Transfer Calculation step 24. The model is also discussed in the Gunn reference heretofore incorporated by reference; surface reaction rates are described by Desai and Wen.

At the beginning of the combustion calculation step 25, certain limits of the system are established. In one embodiment, a limit on the maximum temperature is set to 3000 degrees Kelvin and a maximum limit of 1173 degrees Kelvin on the sorbent temperature is also set. In one embodiment, the calculation results, which will reflect increase in some species and a decrease in others, are stored in a series of two-dimensional structures having two indexes, the cell number (ijk, in one embodiment) and the species number ranging from one to eight, as discussed in Tables 1 and 2.

The transformation numbers are calculated as part of this process for each given species in the cell being reviewed at a given time. In one embodiment, the desired values are stored in a series of matrices, each matrix containing a different value. In one embodiment, the matrices are:

### R_gp, RoX_gc, R_sp, RoX_sc, SUM_R_G, HOR_G, SUM_R_S, HOR_S, R_PHASE

The matrices that contain information regarding reactions, i.e. RoX_sc, R_sp, contain information on the species involved in the reactions and are multi-dimensional, while other data stores (SUM_R_G, HOR_G) do not involve a species and are one-dimensional arrays referencing the value to a cell number.

For each cell reviewed as part of this process, it is separately analyzed for each of the fourteen rates of reaction for that given cell. Each reaction is identified by a letter and a name. The reactions are reflected in the following table:

| Id | Reaction Description |
|---|---|
| a1 | carbon monoxide formation |
| f0 | hydrogen combustion |
| f1 | methane combusition |
| f2 | carbon monoxide combustion |
| f3 | Tar combustion |
| b | carbon monoxide and hydrogen formation |
| c | carbon monoxide formation |
| d | methane formation |
| g | coal moisture |
| h | volatile matter reduction |
| e | water shift reaction |
| i | Tar reduction |
| k | dolomite reduction |
| l | calcite reduction |

### Preliminary Calculations

As part of the Combustion Rate Calculation step 25, prior to the calculation of the first six reactions (a1 through f3 above), it is necessary to establish values of a number of variables used in the calculations. Prior to the calculation of the reaction rates, the temperatures of the system are retrieved along with the pressures within the cell under analysis.

First, the temperature of the gas, the solid carbon, and the sorbent temperature of the solid in the cell are retrieved. In one embodiment, this is stored in the variable TGX, the temperature of the carbon is stored in TS1X, and the sorbent temperature of the solid is stored in TSorb1. Finally the average of the two solid temperatures is calculated and stored in TGS1X, per one embodiment.

Next, the partial pressures of various gasses in the cell atmosphere are calculated. The pressure of the gas phase of the cell is stored in an array keyed to the cell number. For example, the variable P_g(ijk) will contain the pressure of the gas phase of the cell at position ijk. The units stored in P_g array are dynes per cm². The calculations of the partial pressure proceed as follows:

PATM=P_{—}g(IJK)/1013000.

PATM_MW=PATM*MW_MIX_{—}g(IJK)

PO2=PATM_MW*X_{—}g(IJK,1)/MW_g(1)

PCO=PATM_MW*X_{—}g(IJK,2)/MW_{—}g(2)

PCO2=PATM_MW*X_{—}g(IJK,3)/MW_{—}g(3)

PCH4=PATM_MW*X_{—}g(IJK,4)/MW_{—}g(4)

PH2=PATM_MW*X_{—}g(IJK,5)/MW_{—}g(5)

PH2O=PATM_MW*X_{—}g(IJK,6)/MW_{—}g(6)

EP_{—}s1=EP_{—}s(IJK,1)

X_coal1=X_{—}s(IJK,1,1)+X_{—}s(IJK,1,2)+X_{—}s(IJK,1,3)+X_{—}s(IJK,1,4)

In the above calculations P_g(IJK) is the pressure at cell number IJK, MW_MIX_g(IJK) contains the value of molecular weight of cell IJK, while variable X_g(IJK,species#) contains the mass fraction of the gas species for the given gas species which is specified in the gas species. Analogously, the MW_g(species#) provides the molecular weight for each of the gaseous species. The variable EP_s1 stores the multiplicative factor of epsilon. The final preliminary calculation is that for the concentration of carbon. In one embodiment, this calculation is:

CAR1=ROP_{—}s(IJK,1)*X_{—}s(IJK,1,1)/MW_{—}s(1,1)

Where the ROP_s(IJK,1) is the value of the solids density times the solids fraction, X_s(IJK,1,1) contains the mass fraction of the fixed carbon in the solid phase, and MW_s contains the molecular weight of the fixed carbon in the solid phase.

### Rates of Combustion Reactions

Once these initial values are calculated, Combustion Rate Calculation step 25 elucidates combustion reactions. Calculation of the first set of combustion reactions requires the partial pressure of oxygen, stored as PO2 in one embodiment, to exceed zero. Inasmuch as the combustion reactions involving oxygen do not occur in its absence, they are not modeled when the partial pressure of oxygen is zero.

### Oxygen-Consuming Reactions

Presuming that there is oxygen in the system, the first reaction that will be modeled is the generation of carbon monoxide:

2C+O₂-->200 a1)

This first reaction is modeled in the source code as:

R_D1=(X_{—}s(IJK,1,1)*PAA/(X_{—}s(IJK,1,4)*PAFC))̂(⅓)

Within this calculation X_s(IJK,1,1) refers to the mass fraction of fixed carbon at cell number IJK, PAA refers to the ash fraction, and X_s(IJK,1,4) refers to the mass fraction of ash in the solid phase, and PAFC refers to the fixed carbon fraction in the proximate analysis. The result is compared with 1 and set to 1 if it is greater than 1. To avoid division by zero errors (for example, should the ash fraction be zero), the result is set to zero prior to this calculation.

Next, a reaction difference variable is calculated, which is used in the intermediate reaction calculations. This variable is set to:

DIFF=4.26*((TGX/1800.)**1.75)/PATM

Presuming that R_D1 is greater than zero, two new intermediate transfer values are calculated. In one embodiment, these are stored in K_f and K_r, which are calculated as:

K_{—}f=DIFF*N_{—}sh(IJK,1)/(D_{—}p(IJK,1)*R_O2*TGX)

K_{—}r=8710.*EXP(−27000./1.987/TS1X)*R_D1*R_D1

Where N_sh(IJK,1) is the mass transfer coefficient of the fixed carbon calculated previously, R_O2 is a gas constant, D_p(IJK,1) is the diameter of the particles of the Oxygen gas in the IJK cell and TGX is the temperature of the gas in the cell. In the second intermediate calculation, TS1X is the temperature of the fixed carbon in the solid, and R_D1 refers to the result of the earlier calculation.

A third reaction value is also calculated:

K_{—}a=2.*DIFF*f_EP_A*R_D1/(D_{—}p(IJK,1)*(1−R_D1)*RÔ2*TS1X)

Where f_EP_A refers to the void fraction of the ash layer and the other variables have already been discussed. The first reaction rate can thus be calculated as:

RXNA=1/(1/K_{—}f+1/K_{—}r)

The final reaction rate is calculated based on this reaction rate using one more prior calculation: FAC=X_s(IJK,1,1)/(X_s(IJK,1,1)+1E−6). The final reaction rate is:

RXNA1F=RXNA*PO2*FAC*6.0*EP_{—}s1/(D_{—}p(IJK,1)*32.0)

The variables involved in the final reaction rate had been discussed above.

The present step 25 then calculates the next oxygen-requiring combustion reaction, which is the combustion of hydrogen gas into water. The reaction is described using the following:

2H₂+O₂-->2H₂O(mol/cm̂3.s) f₀)

The calculation involved in this combustion requires that the partial pressure calculation for hydrogen, stored in PH2, resulted in an amount that is greater than zero. The reaction is calculated as follows:

RXNF0F=1.08E16*EXP(−30000.0/(1.987*TGX))*EP_{—}g(IJK)*(RO_{—}g(IJK)*X_{—}g(IJK,1)/MW_{—}g(1))*(RO_{—}g(IJK)*X_{—}g(IJK,5)/MW_{—}g(5))

Wherein the EXP(x) function returns the natural exponent of the parameter x, TGX is the maximum temperature of the gas as described above, the EP_g(IJK) contains the value of the voidage (a field variable calculated by the EE model) of the gaseous phase of the cell found at location IJK, RO_g(IJK) stores the average molecular weight at position IJK, X_g(IJK,1) contains the mass fraction of the gas species for oxygen gas at cell in position IJK while X_g(IJK,5) stores the same information for hydrogen gas at the same cell.

The next combustion reaction modeled as part of step 25 is that of methane in the system. The combustion reaction is described as:

CH₄+2O₂-->CO₂+2H₂O f₁)

In order for this reaction to occur, the partial pressure calculation for methane, the results of which are stored in PCH4, must be greater than zero. The formula for simulating the results of this reaction is:

$$RXNF 1 F = 6.7 E 12 * EXP ( - 48400.0 / ( 1.987 * TGX ) ) * EP\_g ( IJK ) * ( RO\_g ( IJK ) * X\_g ( IJK , 1 ) / MW\_g ( 1 ) ) ** 1.3 * ( RO\_g ( IJK ) * X\_g ( IJK , 4 ) MW\_g ( 4 ) ) ** 0.2$$

In one embodiment, the results are stored in the variable RXNF1F. The variables involved in the reaction have been described previously as the various Eulerian-Eulerian field variables (EP_g, RO_g, X_g, and MW_g) as well as the temperature limit, TGX.

Next, the step 25 models the combustion of Carbon Monoxide. The formula representing the combustion of carbon monoxide is:

CO+½O₂-->CO₂ f₂)

The simulation of the reaction first verifies that the partial pressure of carbon monoxide is greater than zero. If carbon monoxide is present in the system, the calculation can proceed as:

$$RXNF 2 F = 3.98 E 14 * EXP ( - 40000.0 / ( 1.987 * TGX ) ) * EP\_g ( IJK ) * ( RO\_g ( IJK ) * X\_g ( IJK , 1 ) MW\_g ( 1 ) ) ** 0.25 * ( RO\_g ( IJK ) * X\_g ( IJK , 2 ) / MW\_g ( 2 ) ) * ( RO\_g ( IJK ) * X\_g ( IJK , 6 ) / MW\_g ( 6 ) ) ** 0.5$$

Again, the variables involved in this calculation are the values of the Eulerian-Eulerian field (EP_g, RO_g, X_g, MW_g), and the temperature value TGX discussed previously.

The final combustion reaction accounted by step 25 involves tar. The formulaic representation of the reaction is:

Tar+f3_{—}1O₂-->f3_{—}3CO₂+f3_{—}6H₂O f₃)

The tar combustion reaction requires tar to be present in the system, and this information is stored in the Eulerian-Eulerian field in X_g(IJK,8). The formula for calculating tar combustion is:

$$RXNF 3 F = 3.8 E 11 * EXP ( - 30000.0 / ( 1.987 * TGX ) ) * EP\_g ( IJK ) * ( RO\_g ( IJK ) * X\_g ( IJK , 1 ) / MW\_g ( 1 ) ) ** 1.5 * ( RO\_g ( IJK ) * X\_g ( IJK , 8 ) / MW\_g ( 8 ) ) ** 0.25$$

The variables involved in this combustion step are analogous to the previous combustion reactions. The end result of the combustion reactions is that the resulting forward rate of change in each reactant within each cell is known. In one embodiment, these rates of change are stored in variables RXNF3F (tar), RXNF2F (CO), RXNF1F (methane), RXNF0F (hydrogen), RXNA1F (CO formation).

### Gasification Reactions

The second set of reactions modeled by step 25 require the solids fraction, stored in EP_s1 in one embodiment, discussed above to be greater than zero.

The first reaction to be modeled involves the formation of carbon monoxide and hydrogen gas and is expressed as:

C+H2O-->CO+H2 b)

In order to clarify the calculations involved in this reaction, they are divided into two intermediate steps, combined into one calculation. The first step calculates a value

EQ2=EXP(17.2931−16326.1/TGS1X)

Where the TGS1X is described as part of the initialization of this step. The second intermediate calculation generates the RXNB value:

RXNB=AK2*EXP(−AE2/(1.987*TGS1X))*CAR1.

The variables involved in this calculation originate from the Eulerian-Eulerian field and constants from the first step of the progress (kinetic constants AK2, AE2) or values generated at the beginning of this step of the process (TGS1X and CAR1), all of which had been described above.

Next, the second intermediate value (RXNB) is multiplied by the partial pressure of the water (PH2O) to arrive at the forward rate of reaction value, stored in RXNB1F in one embodiment:

RXNB1F=RXNB*PH2O.

The reverse reaction value multiplies the second intermediate value with the partial pressure of the hydrogen (PH2), the partial pressure of the carbon monoxide (PCO), and then divides by the first intermediate value (EQ2). In one embodiment, the backward reaction calculation is:

RXNB1B=RXNB*PH2*PCO/EQ2.

The next reaction in this set involves the formation of carbon monoxide from carbon and carbon dioxide:

C+CO₂-->200 c)

As before, the calculation involved in modeling this reaction has two intermediate steps and two resulting values used in later computations. The two preliminary calculations are:

EQ5=EXP(20.9238−20281.8/TGS1X)

RXNC=AK5*EXP(−AE5/(1.987*TGS1X))*CAR1

These calculations again involve variables whose values are either provided by the Eulerian-Eulerian model or are calculated earlier in the process, such as TGS1X, which was retrieved earlier as part of the current calculations step 25. Based on these two preliminary calculations, the final reaction modeling can calculate the forward rate of reaction and the backward rate of reaction, which are respectively:

RXNC1F=RXNC*PCO2(forward rate)

RXNC1B=RXNC*PCO*PCO/EQ5(backward rate)

The variables involved in both rates have been discussed previously.

Next, the system models the rate of formation of methane, using the following formula:

½C+H₂-->½CH₄ d)

Analogously to the earlier calculations, the two rates of change are calculated using some preliminary calculations which are stored in temporary variables. The two temporary calculations are:

EQ6=EXP(−13.4289+10998.5/TGS1X)

RXND=EXP(−7.0869−8077.5/TGS1X)*CAR1

The two variables involved, TGS1X and CAR1 have been previously discussed, either as part of the current step 25 or a prior step. Given these two preliminary calculations it is possible to determine the forward and backward rates of the reaction. These are:

RXND1F=RXND*PH2(forward rate)

RXND1B=RXND*SQRT(MAX(PCH4,ZERO)/EQ6)(reverse rate)

The accounting of the reverse rate includes basic error checking. For example the calculation ensures that the system contains sufficient amounts of methane, stored as PCH4, before attempting to calculate the amount used in the reverse reaction. Otherwise, a negative value reflected in PCH4 would result in the square-root returning an imaginary number, thereby introducing several problems into the calculations of the invented system. However, other than that complication, the calculation of the two rates uses variables already known within the system.

### Step 6: Moisture Release, Devolitization, Water Shift and the Tar Cracking Rates Calculation Detail;

Next, the moisture release, devolitization and tar cracking rates are calculated using the stoichiometric coefficients found in step 22. The current step 26, models the reactions involving more complex reactants than the ones disclosed in step 25 and earlier steps. For example, the below reaction illustrates the conversion of coal moisture to H₂O in gaseous form. The reaction is described as follows:

COAL MOISTURE-->H₂O g)

Inasmuch as the reverse of this reaction is not possible in the present system, the backwards rate of this reaction is fixed at zero. In one embodiment this is stored as RXNGB. However, the forward rate can be calculated using the following formula:

RXNGF=AKM*EXP(−AEM/(1.987*TS1X))*ROP_{—}s(IJK,1)*X_{—}s(IJK,1,3)

The result is the forward rate of the conversion of coal moisture to water vapor. The variables involved in this calculation have already been described as part of step 25.

The next reaction is the calculation of the conversion of volatile matter into tar and gases. The reaction can be described as:

VOLATILE MATTER-->TAR+GASES h)

The reaction has both a forward rate and a backward rate, which are calculated using the following:

$$RXNHF = AKD * EXP ( - AED / ( 1.987 * TS 1 X ) ) * ROP\_s ( IJK .1 ) * ( X\_s ( IJK , 1 , 2 ) / X\_coal 1 ) RXNHB = AKD * EXP ( - AED / ( 1.987 * TS 1 X ) ) * ROP\_s ( IJK , 1 ) * VMSTAR ( IJK )$$

These two rates involve the same variables as previously described. For example, as used in the present step 26, the VMSTAR(IJK) entry contents were initialized in step 23 above. If there is insufficient volatile matter left in the cell, the two rates are set to zero.

The next complex reaction modeled as part of the current step 26 is the water-gas shift reaction. It can be represented as:

CO+H₂O-->CO₂+H₂ e)

In one embodiment, the calculation of the two rates requires five intermediate numbers to be generated. The calculations involved in each intermediate step are already defined and have been discussed above. The five intermediate calculations are:

A3=WG3*2.877E+05*EXP(−27760.0/(1.987*TGS1X))

EQ3=EXP(−3.63061+3955.71/TGS1X)

A4=(PATM**(0.5−PATM/250.))/PATM/PATM

A5=EP_{—}s1*PAA*RO_{—}s(1)*EXP(−8.91+5553.0/TGS1X)

RXNE=A3*A4*A5*EP_{—}g(IJK)

Where EP_g, C, and RO_s are Eulerian-Eulerian field arrays, WG3, and PAA are kinetic or stoichiometric constants for the coal being analyzed that were initiated in the second step of the process. TGS1X was discussed above as the temperature of the cell. PATM represents the partial pressure as discussed above. Following the intermediate calculations, it is possible to calculate the final forward and backward rates. These are represented by the following equations:

RXNEF=RXNE*PCO*PH2O

RXNEB=RXNE*PCO2*PH2/EQ3

Where PCO, PH2O, PCO2, and PH2 are partial pressures described previously. RXNE and EQ3 are two intermediate calculation values described above.

The last reaction to be modeled by the system as part of the present step 26 is the tar cracking reaction. The reaction is represented by the following:

TAR-->CHAR+GASES i)

It is assumed that tar cracking is catalyzed by char and that the resulting carbon is deposited on char. Inasmuch as the reaction is not reversed within the system, only the forward rate of this transformation is calculated. Specifically, this rate is calculated as follows:

RXNIF=AKC*EXP(−AEC/(1.987*TGX))*ROP_{—}g(IJK)*X_{—}g(IJK,8)

The stoichiometric constant for the coal being analyzed is stored in AKC and AEC, the temperature of the solid is stored in TGX, and the Eulerian-Eulerian field arrays are ROP_g and X_g, as discussed supra.

At the conclusion of this step, the reaction rates for the tar cracking (RXNIF), the water-gas shift rate (RXNEF), the devolatilization rates (RXNHF, and RXNHB) as well as the coal moisture release rate (RXNGF) are all known. The rates facilitate the calculation of the following process steps.

### Step 7: Determine if Additional Chemistry Mechanisms are Applicable

Once reaction rates are calculated, depending on the application other reaction rates could be added and calculated as part of optional step 8. The decision to do so is shown as block 27 within the flowchart of FIG. 3. If no additional reactions are needed the process skips to the following step represented as block 29, bypassing the eighth step discussed below.

Step 8: Calculate Sorbent Reactions, Effects of Minerals within the Coal, and Other Additional Reaction Rates, as they are Developed

The invented system accommodates additional reactions within this step 28. Forward and backward rates for other reactions, which would be called RXNK1F, RXNK1B. and RXNL1F, RXNL1B for reactions k and l respectively, are included in the subsequent calculations, but would be set to zero unless the reactants involved in reactions k and l (dolomite and calcite) are active in the system. If these two solid species are active, their reaction rates are calculated as well.

Specifically, in one embodiment, the k-th reaction would model the rates of conversion of dolomite in the following reaction:

CaMg(CO₃)₂--->CaCO₃+MgO+CO₂ k)

The reaction forward rate for the dolomite reduction would be calculated as follows:

RXNK1F=2.E08*EXP(−51000./(1.987*TSORB1))*ROP_{—}s(IJK,1)*X_{—}s(IJK,1,6)/MW_{—}s(1,6)

The variables used as part of the calculation of this reaction rate have been described above. Inasmuch as the backward reaction is not possible with in the system, the backward rate would be set to zero, i.e. RXNK1B=0.

Further the next reaction to be considered is the calcite reduction reaction. It would be called the 1-th reaction. The forward reaction rate would be calculated as:

RXNL1F=1.3E10*EXP(−55000./(1.987*TSORB1))*ROP_{—}s(IJK,1)X_{—}s(IJK,1,5)/MW_{—}s(1,5)

Again, all of the variables discussed in this calculation are described above. The backward rate can be calculated with one intermediate calculation. The backward rate is calculated using the Eulerian-Eulerian model arrays as:

EQCaO1=1.03E08*EXP(−21830./TSORB1)

RXNL1B=RXNL1F*PCO2/EQCaO1*(X_{—}s(IJK,1,7)/(X_{—}s(IJK,1,7)+1.e−4))

### Step 9: Rate of Formation, Consumption, and Heat Reaction Calculation Detail

Finally, inasmuch as the invented system has available to it the required precursor information in the present step 29 the system can calculate the rate of formation and consumption of gas and solid species, the amount of mass transferred between the gas and solids phase, and the heat of reaction are determined from the reaction rate information. In one embodiment, the reaction rates are calculated in the rrates.f subroutine this step corresponds to block 29 in FIG. 3.

In step 26 (and optionally step 28), the reaction rates were calculated and stored (as double-precision real numbers in one embodiment). Also in one embodiment, the names of the variables follow a pattern where the first three letters of the name are RxN followed by a letter identifying the reaction (from A to I including several two-character identifiers such as F1, F2, and F3) which is then followed by a flag indicating whether the reaction is forward or backward.

Regardless of the storage chosen for the reaction rates, the output of the previous step 26 or steps 26 and 28 is a set of reaction rates. These reaction rates represent the reactions that are occurring in the cell of the Eulerian-Eulerian flow field being analyzed during the present iteration of the process. The formation rates are added and stored for each species separately and stored for the particular cell.

In one embodiment of the invention, the formation rates are stored in a two-dimensional array wherein the first parameter is the cell number (ijk) and the second parameter is the species number (from 1 to 8 as described in Table 1 and Table 2). In one embodiment, the consumption rates are stored in an analogous manner. While any name can be assigned to the data storage, in one embodiment, the formation rates are stored in a two-dimensional array R_gp while the consumption rates are stored in RoX_gc.

### Gas and Solid Phase Species Calculations

With the reaction rates calculated in step 26, as well as values from the Eulerian-Eulerian field, it is possible to determine the rates of formation and consumption of the components of the gas phase and the solid phase.

### Oxygen

The first species to be considered is oxygen gas. The formation rate is set to zero inasmuch as the combustion processes primarily only use oxygen and do not form it. As such, R_gp(IJK,1) is set to zero. The consumption rate, however, can be calculated. The consumption rate of oxygen is based on the reaction rates of reactions for reactions that require oxygen, which are reactions a1 (carbon monoxide formation), f0 (hydrogen combustion), f1 (methane combustion), f2 (carbon monoxide combustion), and f3 (tar combustion). Also relevant is the mass fraction of oxygen in the cell as stored in the Eulerian-Eulerian model, stored as X_g(IJK,1), and the molecular weight of oxygen, MW_g(1). The stoichiometric coefficient of tar combustion, calculated in an earlier step, is also used in this calculation. In one embodiment, the tar stoichiometric coefficient is stored as f3_{—}1. Using these variables, the rate of oxygen consumption is calculated as:

RoX_{—}gc(IJK,1)=(RXNA1F+RXNF0F+2.*RXNF1F+HALF*RXNF2F+f3_{—}1*RXNF3F)*MW_{—}g(1)/X_{—}g(IJK,1)

The above calculation presumes that the cell still contains some oxygen. If the fraction of oxygen in the cell is zero or less, in place of the above calculation the rate of Oxygen consumption is set to a negligible number, for example, 1×10⁻⁹ to signify zero consumption. The same negligible amount is used for all consumption rates that are virtually zero.

### Carbon Monoxide

The second gas specie is carbon monoxide. Unlike oxygen, carbon monoxide is both formed and consumed as part of the reactions in the combustion model. As such, there are two amounts that must be computed.

The rate of carbon monoxide production is affected by reactions a1 (carbon monoxide formation), b (carbon monoxide and hydrogen formation), c (carbon monoxide formation), e (water shift reaction), h (volatile matter reduction) and i (tar reduction). The calculation also factors carbon monoxide coefficient for the tar cracking reaction and the carbon monoxide coefficient for the devolatilization reaction. These coefficients were calculated during an earlier step of the process and, in one embodiment, are stored in BetaC and BetaD respectively. The molecular weight of carbon monoxide, stored in MW_g in one embodiment, is also considered in the formation rate. The calculation is then:

$$R\_gp ( IJK , 2 ) = ( 2 * ( RXNA 1 F ) + RXNB 1 F + 2. * ( RXNC 1 F ) + RXNEB ) * MW\_g ( 2 ) + ( RXNHF - RXNHB ) * BETA D ( 2 ) + RXNIF * BETA C ( 2 )$$

The consumption rate is calculated in an analogous manner, except the calculation is based on different reaction rates. Specifically, the consumption rate relies on reactions b (carbon monoxide and hydrogen formation), c (carbon monoxide formation), e (water shift reaction), and f2 (carbon monoxide combustion). Also considered is the mass fraction of carbon monoxide, stored in X_{—}g(IJK,2) and the molecular weight use in the formation reaction. The calculation proceeds as follows:

$$RoX\_gc ( IJK , 2 ) = ( RXNB 1 B + 2. * ( RXNC 1 B ) + RXNEF + RXNF 2 F ) * MW\_g ( 2 ) / X\_g ( IJK , 2 )$$

If the mass fraction of carbon monoxide is zero or less, the above calculation does not take place but instead the value is set to the negligible number discussed above.

### Carbon Dioxide

The next species considered by step 29 is carbon dioxide. The formation rate of CO₂ is calculated using the rates of reactions c (carbon monoxide formation), e (water shift reaction), f1 (methane combusition), f2 (carbon monoxide combustion), f3 (tar combustion), k (dolomite reduction), l (calcite reduction), h (volatile matter reduction), i (tar reduction).). The calculation also uses the carbon dioxide coefficient for the tar cracking reaction and the carbon dioxide coefficient for the devolatilization reaction and tar combustion constants. In one embodiment these are BetaC, BetaD, and F3_{—}3 respectively. The calculation then proceeds as:

$$R\_gp ( IJK , 3 ) = ( RXNC 1 B + RXNEF + RXNF 1 F + RXNF 2 F + \\ F 3 \_ 3 * RXNF 3 F + RXNK 1 F + RXNL 1 F ) * MW\_g ( 3 ) + ( RXNHF - RXNHB ) * BETA D ( 3 ) + RXNIF * BETA C ( 3 )$$

The rate of consumption of carbon dioxide is also calculated. The reactions of interest in this rate are c (carbon monoxide formation), e (water shift reaction), l (calcite reduction) along with the molecular weight of carbon dioxide and its volume fraction within the cell. The calculation comprises the following:

RoX_{—}gc(IJK,3)=(RXNC1F+RXNEB+RXNL1B)*MW_{—}g(3)/X_{—}g(IJK,3)

Again, if the volume fraction of carbon dioxide is zero or negative, the rate of consumption is set to the negligible constant number.

### Methane

The fourth gaseous species examined by the present step 29 is methane. The formation of methane involves reactions d (methane formation), h (volatile matter reduction), and i (tar reduction). The methane coefficient for the tar cracking reaction and the methane coefficient for the devolatilization reaction are also part of the calculation along with the molecular weight of methane. As such, the calculation is:

R_{—}gp(IJK,4)=HALF*(RXND1F)*MW_{—}g(4)+(RXNHF−RXNHB)*BETAD(4)+RXNIF*BETAC(4)

The rate of consumption of methane is also calculated. This involves reactions d (methane formation), and f1 (methane combustion) along with the molecular weight of methane and the mass fraction of methane. The actual calculation is:

RoX_{—}gc(IJK,4)=((RXND1B)*HALF+RXNF1F)*MW_{—}g(4)/X_{—}g(IJK,4)

In the event that there is no methane remaining in the cell, this rate is set to the negligible constant discussed above.

### Hydrogen

The fifth gaseous species is hydrogen. The formation of hydrogen involves reactions b (carbon monoxide and hydrogen formation), d (methane formation), e (water shift reaction), h (volatile matter reduction), and i (tar reduction) along with the hydrogen coefficients for the tar cracking and devolatilization reaction and finally the molecular weight of hydrogen. The formation rate is calculated as:

R_{—}gp(IJK,5)=(RXNB1F+RXND1B+RXNEF)*MW_{—}g(5)+(RXNHF−RXNHB)*BETAD(5)+RXNIF*BETAC(5)

The rate of consumption of hydrogen is calculated using reaction rates for reaction b (carbon monoxide and hydrogen formation), d (methane formation), e (water shift reaction), and f0 (hydrogen combustion). The calculation also takes into account the molecular weight of hydrogen, and the hydrogen gas mass fraction. The calculation is then:

$$RoX\_gc ( IJK , 5 ) = ( RXNB 1 B + RXND 1 F + RXNEB + 2 * RXNF 0 F ) * MW\_g ( 5 ) / X\_g ( IJK , 5 )$$

Alternatively, the consumption rate is set to the negligible number of the cell did not contain hydrogen gas to be consumed.

### Water

The sixth gaseous species is water examined by the present step 29. Its rate of formation is set by reactions b (carbon monoxide and hydrogen formation), e (water shift reaction), f0 (hydrogen combustion), f1 (methane combustion), f3 (tar combustion), g (coal moisture), h (volatile matter reduction), and i (tar reduction). Inasmuch as the volatile matter and tar reduction reactions are involved, the water coefficient for these two reactions is also considered as part of the calculation. Specifically, the calculation is:

$$R\_gp ( IJK , 6 ) = ( RXNB 1 B + RXNEB + 2. * RXNF 0 F + 2. * RXNF 1 F + F 3 \_ 6 * RXNF 3 F ) * MW\_g ( 6 ) + RXNGF + ( RXNHF - RXNHB ) * BETA D ( 6 ) + RXNIF * BETA C ( 6 )$$

The rate of water consumption involves the reaction rates of reactions b (carbon monoxide and hydrogen formation) and e (water shift reaction). The consumption rate is calculated as:

RoX_{—}gc(IJK,6)=(RXNB1F+RXNEF)*MW_{—}g(6)/X_{—}g(IJK,6)

### Nitrogen

The seventh gaseous species considered by the present invention is nitrogen gas (N₂). The rate of reaction of nitrogen is not factored in some embodiments of the invention inasmuch as Nitrogen is treated as an inert gas. In these embodiments, the rates of consumption and formation are both set to zero. However, the rate could be calculated if reactions involving nitrogen gas were included in the system.

### Tar as Gaseous Species

The final, or eighth, gaseous species considered by the present step 29 is tar. The rate of formation of tar is calculated from the reaction rates of reaction h (volatile matter reduction) and the tar fraction in the devolatilization constant (AlphaD) calculated in the second step of this process. The specifics of this calculation are:

R_{—}gp(IJK,8)=(RXNHF−RXNHB)*ALPHAD

The tar consumption calculation involves reactions f3 (tar combustion) and i (tar reduction) along with the molecular weight of tar and the mass fraction of tar in the gas. The tar consumption rate is calculated as:

RoX_{—}gc(IJK,8)=(RXNF3F*MW_{—}g(8)+RXNIF)/X_{—}g(IJK,8)

Again, if the tar amount is insufficient to be consumed, the consumption rate is set to the negligible constant.

### Solid Species Storage

Following the calculation of the rates of formation and consumption of the gas specie, the process next considers the rates of formation and consumption of each of the species found in the solid phases.

The rates for each of the eight species is stored analogously to the gaseous species, except that the rates are stored in a three-dimensional structure. The third dimension for each variable is the solid phase number which allows the system to account for additional solid phases within the solid phase as part of the analysis of the present step 29. In one embodiment, however, as reflected in the calculations below, the invention treats the entire solid phase as one group. In one embodiment of the invention, each rate is stored in a three-dimensional variable where the first index is the cell number, the middle index is the solid phase number, and the final index is the solid phase species. For example, in one embodiment the rate of formation can be stored in the variable R_sp which has three dimensions—(cell_number, phase_number, species_no) such that the rate of formation of carbon in solid phase number 1 at cell ijk is found in variable R_sp(ijk,1,1). In an embodiment of the invention, the rate of consumption is stored in an analogously-structured three-dimensional variable RoX_sc.

### Carbon

The first solid species analyzed as part of the present step 29 is carbon. The rate of formation is determined by the rate of reactions b (carbon monoxide and hydrogen formation), c (carbon monoxide formation), d (methane formation), and i (tar reduction). Also considered is the molecular weight of carbon, stored in a variable called MW_s(1,1) in one embodiment, and the char fraction calculated as part of the second step, stored in AlphaC. The formation calculation is therefore:

R_{—}sp(IJK,1,1)=(RXNB1B+RXNC1B+HALF*RXND1B)*MW_{—}s(1,1)+RXNIF*ALPHAC

The consumption of carbon in the first solid species is also calculated using the rates of reactions a1 (carbon monoxide formation), b (carbon monoxide and hydrogen formation), c (carbon monoxide formation), and d (methane formation). The molecular weight of carbon is also used in the calculation along with the carbon mass fraction of the solid species. The carbon mass fraction is stored in the variable X_s(ijk,1,1) in one embodiment. The calculation of the rate of consumption of carbon then proceeds as:

RoX_{—}sc(IJK,1,1)=(2.*RXNA1F+RXNB1F+RXNC1F+HALF*RXND1F)*MW_{—}s(1,1)/X_{—}s(IJK,1,1)

As was the case with the gaseous specie, if the mass fraction of carbon is zero or less, the rate of consumption is set to the negligible constant for solid specie, which is selected to be any low number, such as 1*10⁻⁷, in one embodiment.

### Volatile Matter

The second solid species considered by this process is the volatile matter. The rate of formation of the volatile matter was already determined and is reflected in the rate of reaction h (volatile matter reduction). As such, the rate of formation of volatile matter is simply:

R_{—}sp(IJK,1,2)=RXNHB

The rate of volatile matter consumption is also based on reaction h (volatile matter reduction), but also involves the mass fraction of the volatile matter, stored in X_s(ijk, 1, 2). Specifically, the calculation of volatile matter consumption is:

RoX_{—}sc(IJK,1,2)=RXNHF/X_{—}s(IJK,1,2)

In case of the mass fraction being zero or less, the rate of consumption is set to the negligible constant amount.

### Moisture

The third solid species modeled by step 29 is the moisture. It is handled in the same manner as the rates of the volatile matter. The rate of formation is set by reaction g (coal moisture):

R_{—}sp(IJK,1,3)=RXNGB

The rate of consumption is likewise a function of reaction g (coal moisture), but also involves the mass fraction of the moisture:

RoX_{—}sc(IJK,1,3)=RXNGF/X_{—}s(IJK,1,3)

Finally, the rate of consumption is set to the negligible constant for solid species with insufficient moisture content.

### Ash

The fourth solid species is ash. However, ash is inert in the system, and as such both the rates of reaction of ash are set to zero:

R_{—}sp(IJK,1,4)=0

RoX_{—}sc(IJK,1,4)=0

### Calcium Carbonate

The fifth solid species is calcium carbonate (CaCO₃). Its rate of formation is set by the rates of reactions k (dolomite reduction) and l (calcite reduction) discussed as part of optional step 28. The rates also rely on the molecular weight of calcium carbonate, stored in variable MW_s(1,5), in one embodiment. Specifically, the formula for calculation for this rate is:

R_{—}sp(IJK,1,5)=(RXNK1F+RXNL1B)*MW_{—}s(1,5)

The rate of formation of calcium carbonate considers just reaction l (calcite reduction) along with the mass fraction of calcium carbonate, stored in X_s and the molecular weight discussed in the formation reaction. The calculation proceeds as follows:

RoX_{—}sc(IJK,1,5)=RXNL1F*MW_{—}s(1,5)/X_{—}s(IJK,1,5).

If there is insufficient calcium carbonate in the system, this rate is set to the negligible constant or zero.

### Dolomite

The sixth solid species is dolomite—CaMg(CO₃)₂. This solid species is not formed by the process and so the rate of formation is set to zero. In one embodiment, this is accomplished by the following:

R_{—}sp(IJK,1,6)=0

The rate of dolomite consumption is based on the rate of reaction k (dolomite reduction), the molecular weight of dolomite, and the fraction rate of dolomite. The calculation of this rate is as follows:

RoX_{—}sc(IJK,1,6)=RXNK1F*MW_{—}s(1,6)/X_{—}s(IJK,1,6)

If there is zero dolomite in the solid phase, this rate is also set to zero in lieu of this calculation.

### Calcium Oxide

The seventh solid species is calcium oxide—CaO. Its rate of formation is based on the molecular weight of calcium oxide, stored in MW_s(1,7) in one embodiment of the invention, and the rate of reaction l (calcite reduction). The calculation is therefore as follows:

R_{—}sp(IJK,1,7)=RXNL1F*MW_{—}s(1,7)

The rate of consumption of calcium oxide involves these same variables, except that the mass fraction of calcium oxide within the solid phase, as reflected by X_s(IJK,1,7), is also factored in. The calculation is therefore:

RoX_sc(IJK,1,7)=RXNL1B*MW_{—}s(1,7)/X_{—}s(IJK,1,7)

The rate is set to zero or a negligible number if there is no calcium oxide in the solid phase.

### Magnesium Oxide

The final solid species rate calculated as part of step 29 is magnesium oxide. The rate of formation is determined by multiplying the rate of reaction k (dolomite reduction) with the molecular weight of magnesium oxide. The calculation is therefore:

R_{—}sp(IJK,1,8)=RXNK1F*MW_{—}s(1,8)

Inasmuch as magnesium oxide is not consumed by the system, the rate of consumption for this final solid species is set to zero.

At the conclusion of this process, the rates of formation and reaction of each of the species both in the solid phase and the gaseous phase are known and stored in memory. These rates will be used in the final step to calculate the formation and consumption of each solid and gas species.

However, prior to moving to the final steps, it is necessary to calculate the amount of mass transferred between the gas and solids phase, and the heat of reaction. These two calculations are described separately below. The solid phase species discussed supra are indication of coal combustion/gasification and so are provided for illustrative purpose. However, other fuels will have additional solid phase products to be scrutinized by the invented system.

### Calculation of Mass Transferred Between the Gas and Solid Phases

The invented process, is designed to model fuel consumption in a gasifier, and such consumption occurs when solid phase elements are transferred to the gas phase. The next phase of step 29 the invented process calculates the amount of mass transferred between the two phases inasmuch as the Eulerian-Eulerian flow field must be updated with this information in the final step. Of particular interest is the transference of mass from each solid phase, if any, to the gas phase.

In one embodiment of the invention, the amount of mass transferred is stored in a two-dimensional array where the first number specifies the phase which receives the matter while the second number specifies the originating phase. In one embodiment of the invention, the gas phase is assigned number 0, and any solid phases are assigned numbers starting with the number 1 assigned to the first solid phase and increases from there. The transfer of the mass from the first solid phase to the gas phase, if stored in a variable called R_tmp, would be stored in the entry R_tmp(0,1).

The calculation of each mass quantity depends on the reaction rates determined in the previous step of the invented process. For the calculation of the amount of mass transferred from the solid-1 phase to the gas phase, the rates of the following reactions are considered: a1 (carbon monoxide formation), b (carbon monoxide and hydrogen formation), c (carbon monoxide formation), d (methane formation), g (coal moisture), h (volatile matter reduction), i (tar reduction), k (dolomite reduction), and l (calcite reduction). Also, the molecular weight of the fixed carbon, as a component of the solid phase, the char fraction amount, and the molecular weight of carbon dioxide are factored into the calculation. In one embodiment of the invention, the molecular weight of carbon is stored in MW_s(1,1), the molecular weight of carbon dioxide is stored in MW_g(3), and the char fraction amount is found in AlphaC.

Given the above variable names, in one embodiment, the calculation of the amount of mass transferred from the solid phase to the gas phase would be calculated as:

$$R\_tmp ( 0 , 1 ) = RXNA 1 F * ( 2. * MW\_s ( 1 , 1 ) ) + ( RXNB 1 F - RXNB 1 B ) * MW\_s ( 1 , 1 ) + ( RXNC 1 F - RXNC 1 B ) * MW\_s ( 1 , 1 ) + ( RXND 1 F - RXND 1 B ) * ( HALF * MW\_s ( 1 , 1 ) ) + RXNGF + ( RXNHF - RXNHB ) - RXNIF * ALPHAC + ( RXNK 1 F + RXNL 1 F - RXNL 1 B ) * MW\_g ( 3 )$$

If the system contains more than one solid phase, then the same calculation would be repeated for each solid phase. The system provides a means for calculating mass transfer for a solid phase separate from each other solid phase whether or not the solid phases interact with each other.

The values of the mass generation for each phase are calculated by adding the reaction rates of all the individual species. These were calculated earlier in the current step 29, for each species. In one embodiment, these rates are stored in memory as entries in an array called R_GP, for example.

Subsequently, the summation of all the reaction rate changes is calculated by adding the reaction rate value for every species. The rate of formation is decreased by the rate of consumption and the final rate is multiplied by the mass fraction of the given species. The total mass generation for the solid phase is therefore calculated as:

SUM_R_G(IJK)=SUM_R_G(IJK)+SUM(R_GP(IJK,:NMAX(0))−ROX_GC(IJK,:NMAX(0))*X_G(IJK,:NMAX(0)))

Where SUM_R_G(IJK) stores the total mass generation of the gas phase at cell number IJK, SUM(R_GP(IJK,:NMAX(0)) represents the sum of all rates of formation of the gas specie, ROX_GC(IJK,:NMAX(0) is the rate of consumption of the gas species, and X_G(IJK,:NMAX(0) stores the mass fractions of all the gas specie.

Analogously, the mass transfer rates of the solid species is calculated as:

SUM_R_S(IJK,M)=SUM_R_S(IJK,M)+SUM(R_SP(IJK,M,:NMAX(M))&−ROX_SC(IJK,M,:NMAX(M))*X_S(IJK,M,:NMAX(M)))

The same variables are involved in this calculation as for the gas specie, except each of the variables calculates sums for the solid specie instead.

### Calculation of the Heat of Reactions

The final calculation for each cell in this step 29 is the heat of reactions. The Eulerian-Eulerian field model maintains the temperatures of both the gas phase and the solid phase. However, the reactions occurring within the system will change both of those numbers inasmuch as each reaction is either exothermic or endothermic. Nonetheless, a heat of reactions is calculated separately for the solid phase and the gas phase.

First the gas phase heat change takes into account the rate of reaction of reactions f0 (hydrogen combustion), f1 (methane combustion), f2 (carbon monoxide combustion), f3 (tar combustion), i (tar reduction), and k (dolomite reduction). Additionally, the heat of the tar cracking reaction (HeatC), and the heat of the tar combustion (HEATF3) are also factored in. In one embodiment of the invention, the calculation of the gas reaction temperature is:

$$HOR\_g ( IJK ) = ( - 115596.0 ) * ( RXNF 0 F - RXNF 0 B ) + ( - 191759.0 ) * ( RXNF 1 F - RXNF 1 B ) + ( - 67636.0 ) * ( RXNF 2 F - RXNF 2 B ) + ( HEATF 3 ) * ( RXNF 3 F - ( RXNF 3 B ) + HEATC * ( RXNIF - RXNIB ) + ( 31000.0 ) * ( RXNK 1 F ) + ( 41000.0 ) * ( RXNL 1 F - RXNL 1 B )$$

Second, the change in temperature of the solid phase is also calculated. The reactions involved in this change in temperature are a1 (carbon monoxide formation), b (carbon monoxide and hydrogen formation), c (carbon monoxide formation), d (methane formation), e (water shift reaction), g (coal moisture), and h (volatile matter reduction). Also factored in is the heat of devolatilization (called HeatD in one embodiment). In one embodiment, the calculation proceeds as follows:

$$HOR\_s ( IJK , 1 ) = ( - 52832.0 ) * ( RXNA 1 F - RXNA 1 B ) \& + ( 31382.0 ) * \\ ( RXNB 1 F - RXNB 1 B ) \& + ( 41220.0 ) * ( RXNC 1 F - RXNC 1 B ) \& + ( - 8944.5 ) * ( RXND 1 F - RXND 1 B ) \& + ( - 9838.0 ) * ( RXNEF - RXNEB ) \& + ( 540.5 ) * RXNGF \& + HEATD * ( RXNHF - RXNHB )$$

### Step 10: Returning to the Eulerian-Eulerian Model the Rate of Formation and Consumption of Gas and Solid Species, and the Amount of Mass Transferred Between the Gas and Solids Phase.

The previous step 29 relied on the rates of all reactions that lead to the formation of a given species and consumption of a given species and calculated a source or sink term based on this information. Finally, as part of the present step 30 the source and sink terms of the various gas and solids species are returned back into the Eulerian-Eulerian model.

Given that the Eulerian-Eulerian field is modeled as a matrix of complex data structures, the updating of the values of the field can be accomplished using methods known in the art.

The governing equations of the Eulerian-Eulerian model include source and sink terms based on the rate of production or consumption. Once these rates are known from the previous steps, the source and sink terms are updated in the Eulerian-Eulerian model.

The invented module then returns the data to the Eulerian-Eulerian model at the steps depicted at point 5 and 6 on FIG. 2.

These terms returned as part of the previous step 30 are used in the continuity, momentum, and species mass balance equations during the iteration process of the Eulerian-Eulerian model to converge the energy, continuity, momentum, and transport equations. In the event that convergence is not reached, the process repeats. When convergence is reached and all field variables are updated and the solution is advanced to the next time step where the entire procedure is repeated again.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1-20. (canceled)

21. A method of simulating the gasification of coal in a coal gasification reactor using a fixed grid of cells at a time point and over a time interval, where the fixed grid of cells describes a partitioning of at least some portion of the coal gasification reactor into a plurality of three-dimensional volumes and where each cell in the fixed grid of cells represents one of the three-dimensional volumes in the plurality of three-dimensional volumes, such that a total volume of the fixed grid of cells is equal to the at least some portion of the coal gasification reactor, in a two-phase flow through the gasification reactor, where the two phase flow is comprised of a solid phase and a gas phase and where the solid phase is comprised of coal particles of the coal, by using a coal chemistry module, where the coal chemistry model determines for each cell in the fixed grid of cells, a gas phase heat, a solid phase heat, a resulting mass change for each separate solid species, a resulting mass change for each separate gas species, a mass transfer to the gas phase, and a mass transfer to the solid phase, by:
A) determining stoichiometric coefficients based on the coal by,
1) determining devolitization stoichiometric coefficients based on devolitization products of the coal, where the devolitization products include at least tar, CO, CO₂, CH₄, H₂, and H₂O, by calculation based on a composition of the coal or by receiving the devolatization stoichiometric coefficients as known quantities,
2) determining tar-cracking stoichiometric coefficients based on tar-cracking products, where the tar-cracking products include at least C, CO, CO₂, CH₄, H₂, and H₂O, by calculation based on a composition of tar in the coal or by receiving the tar-cracking stoichiometric coefficients as known quantities,
3) determining decomposition product stoichiometric coefficients based on decomposition products in the coal, where decomposition products are gaseous and solid products produced by decomposition components in the coal, where the decomposition components are constituents in the coal which decompose under the influence of temperature, and which are not categorized as volatile matter in the coal, tar in the coal, or ash in the coal, based on proximate and ultimate analysis of the coal, where the decomposition stoichiometric coefficients are determined by calculation based on the decomposition components in the coal or by receiving the decomposition stoichiometric coefficients as known quantities,
thereby determining the stoichiometric coefficients based on the coal; and
B) individually analyzing each cell in the fixed grid of cells to determine changes to the gas phase and the solid phase over the time interval by selecting a given cell, where the given cell is one of the cells comprising each cell in the fixed grid of cells, and analyzing the given cell by,
1) representing the gas phase in the given cell as a mass composition of separate gas species, where the mass composition of separate gas species includes a mass composition of at least O₂, CO, CO₂, CH₄, H₂, H₂O, N₂, and tar within the gas phase, and receiving as a known input the mass composition of at least O₂, CO, CO₂, CH₄, H₂, H₂O, N₂, and tar within the gas phase of the given cell,
2) representing the solid phase in the given cell in the fixed grid of cells as a mass composition of separate solid species, where the mass composition of separate solid species includes a mass composition of at least fixed carbon, volatile matter, moisture, ash, decomposition components, and solid decomposition products within the solid phase, and receiving as a known input the mass composition of at least fixed carbon, volatile matter, moisture, ash, decomposition components, and solid decomposition products with the solid phase of the given cell,
3) receiving as known inputs a total pressure for the given cell, a gas velocity for the given cell, a solid velocity for the given cell, a mass of gas phase for the given cell, a mass of solid phase for the given cell, a gas phase temperature for the given cell, and a solid phase temperature for the given cell,
4) determining reaction rates for combustion, gasification, moisture release, volatile release, water gas shift, tar cracking, and decomposition reactions in the given cell by,
a) determining, for each separate gas species in the assigned mass composition of separate gas species in the given cell, a partial pressure, by using the total pressure in the given cell, the mass of gas phase in the given cell, and the mass composition of separate gas species in the given cell, such that at least an O₂ partial pressure, a CO partial pressure, a CO₂ partial pressure, a CH₄ partial pressure, an H₂ partial pressure, an H₂O partial pressure, an N₂ partial pressure, and a tar partial pressure in the given cell is determined for the given cell,
b) determining combustible gas species in the given cell, where a combustible gas species is a gas species in the mass composition of separate gas species expected to combust in the coal gasification reactor, and, if the O₂ partial pressure is greater than zero in the given cell, determining a combustion reaction rate for each combustible gas species, by using the gas phase temperature in the given cell and the mass composition of separate gas species in the given cell with applicable reaction rate of combustion equations, such that at least a CO combustion rate, a CO₂ combustion rate, a CH₄ combustion rate, and an H₂ combustion rate is determined for the given cell,
c) determining a combustion reaction rate for fixed carbon in the given cell if the O₂ partial pressure is greater than zero in the given cell, by determining a mass of fixed carbon in the given cell based on the mass composition of separate solid species in the given cell, and by using the solid phase temperature in the given cell, the mass of fixed carbon in the given cell, the gas velocity for the given cell, and the solid velocity for the given cell with applicable reaction rate of combustion equations,
d) determining reaction rates for gasification for the given cell by at least,
i) determining a forward reaction rate for steam gasification and a backward reaction rate for steam gasification in the given cell, where steam gasification refers to a reaction between the mass of fixed carbon in the given cell and H₂O in the given cell to produce CO and H₂ in the given cell, by using the gas phase temperature in the given cell and the mass of fixed carbon in the given cell and the H₂O partial pressure, the H₂ partial pressure, and the CO partial pressure in the given cell with applicable steam gasification reaction rate equations,
ii) determining a forward reaction rate for CO₂ gasification and a backward reaction rate for CO₂ gasification in the given cell, where CO₂ gasification refers to a reaction between the mass of fixed carbon in the given cell and CO₂ in the given cell to produce CO in the given cell, by using the gas phase temperature in the given cell and the mass of fixed carbon in the given cell and the CO₂ partial pressure and the CO partial pressure in the given cell with applicable CO₂ gasification reaction rate equations,
iii) determining a forward reaction rate for methanation and a backward reaction rate for methanation in the given cell, where methanation refers to a reaction between the mass of fixed carbon in the given cell and H₂ in the given cell to produce CH₄ in the given cell, by using the gas phase temperature in the given cell and the mass of fixed carbon in the given cell and the H₂ partial pressure and the CH₄ partial pressure in the given cell with applicable methanation reaction rate equations,
thereby determining the reaction rates for gasification for the given cell,
e) determining a reaction rate for moisture release in the given cell, where moisture release refers to the release of H₂O from the solid species moisture in the given cell to the gas species H₂O in the given cell, by determining a mass of moisture in the given cell based on the mass composition of separate solid species in the given cell, and by using the solid phase temperature in the given cell and the mass of moisture in the given cell with applicable moisture release reaction rate equations,
f) determining a forward reaction rate for volatile release and a backward reaction rate for volatile release in the given cell, where volatile release refers to the release of the devolitization products from the solid species volatile matter in the given cell to the gas species corresponding to each of the devolitization products in the given cell, by determining a mass of volatile matter in the given cell based on the mass composition of separate solid species in the given cell, and by using the solid phase temperature in the given cell and the mass of volatile matter in the given cell with applicable volatile release reaction rate equations,
g) determining a forward reaction rate for water gas shift and a backward reaction rate for water gas shift in the given cell, where water gas shift refers to a reaction between the gas species CO in the given cell and the gas species H₂O in the given cell to produce the gas species CO₂ in the given cell and the gas species H₂ in the given cell, by using the gas phase temperature in the given cell, the total pressure in the given cell, and the CO partial pressure, the H₂O partial pressure, the CO₂ partial pressure, and the H₂ partial pressure in the given cell with applicable water gas shift reaction rate equations,
h) determining a reaction rate for tar-cracking in the given cell, where tar-cracking refers to the gas species tar in the given cell producing the tar-cracking products in the given cell, by using the gas phase temperature in the given cell and the tar partial pressure in the given cell with applicable tar-cracking reaction rate equations,
i) determining a forward reaction rate for decomposition and a backward reaction rate for decomposition in the given cell for each of the decomposition components and each of the solid decomposition products, where decomposition refers a reaction between the decomposition components and the solid decomposition products from the influence of temperature on the each of the decomposition components and the each of the solid decomposition products, by determining a mass for the each of the decomposition components and a mass for the each of the solid decomposition products in the given cell based on the mass composition of separate solid species in the given cell, and by using the solid phase temperature in the given cell, the mass for the each of the decomposition components in the given cell, and the mass for the each of the solid decomposition products in the given cell with applicable decomposition reaction rate equations,
thereby determining reaction rates for combustion, gasification, moisture release, volatile release, water gas shift, tar cracking, and decomposition reactions in the given cell,
5) determining rates of formation, rates of consumption, the resulting mass change for each separate solid species, the resulting mass change for each separate gas species, the mass transfer to the gas phase, and the mass transfer to the solid phase in the given cell by,
a) determining a rate of formation for each separate gas species in the given cell by using applicable gas formation reaction rates for the each separate gas species, where the applicable gas formation reaction rates for the each separate gas species describe reactions which results in formation of the each separate gas species, and where the applicable gas formation reaction rates are comprised of one or more of the combustion reaction rates for each combustible gas species, the combustion reaction rate for the fixed carbon, the forward reaction rate for steam gasification, the backward reaction rate for steam gasification, the forward reaction rate for CO₂ gasification, the backward reaction rate for CO₂ gasification, the forward reaction rate for methanation, the backward reaction rate for methanation, the reaction rate for moisture release, the forward reaction rate for volatile matter, the forward reaction rate for water gas shift, the backward reaction rate for water gas shift, the reaction rate for tar-cracking, the forward reaction rates for decomposition for the each of the decomposition components, and by using the devolitization stoichiometric coefficients, the tar-cracking stoichiometric coefficients, and the decomposition product stoichiometric coefficients that reflect formation of the each separate gas species in the given cell, and using the rate of formation for the each separate gas species in the given cell and the time interval in order to determine a mass of the each separate gas species formed over the time interval in the given cell, such that the mass of the each separate gas species formed over the time interval in the given cell is determined for at least O₂, CO, CO₂, CH₄, H₂, H₂O, N₂, and tar,
b) determining a rate of consumption for the each separate gas species in the given cell by using applicable gas consumption reaction rates for the each separate gas species, where the applicable gas consumption reaction rates for the each separate gas species describe reactions which results in consumption of the each separate gas species, and where the applicable gas consumption reaction rates are comprised of one or more of the combustion reaction rates for each combustible gas species, the combustion reaction rate for the fixed carbon, the forward reaction rate for steam gasification, the backward reaction rate for steam gasification, the forward reaction rate for CO₂ gasification, the backward reaction rate for CO₂ gasification, the forward reaction rate for methanation, the backward reaction rate for methanation, the backward reaction rate for volatile matter, the forward reaction rate for water gas shift, the backward reaction rate for water gas shift, the backward reaction rates for decomposition for the each of the solid decomposition products, and by using the tar-cracking stoichiometric coefficients when the each separate gas species in the given cell is tar, and using the rate of consumption for the each separate gas species in the given cell and the time interval in order to determine a mass of the each separate gas species consumed over the time interval in the given cell, such that the mass of the each separate gas species consumed over the time interval in the given cell is determined for at least O₂, CO, CO₂, CH₄, H₂, H₂O, N₂, and tar,
c) determining the resulting mass change for each separate gas species based on the difference between the mass of the each separate gas species formed and the mass of the each separate gas species consumed over the time interval in the given cell, such that the resulting mass change for each separate gas species describes a mass change for at least O₂, CO, CO₂, CH₄, H₂, H₂O, N₂, and tar in the gas phase over the time interval is determined for the given cell,
d) determining a rate of formation for each separate solid species in the given cell by using applicable solid formation reaction rates for the each separate solid species, where the applicable solid formation reaction rates for the each separate solid species describe reactions which results in formation of the each separate solid species, and where the applicable solid formation reaction rates are comprised of one or more of the backward reaction rate for volatile matter, the reaction rate for tar-cracking, the forward reaction rates for decomposition for the each of the decomposition components, the backward reaction rates for decomposition for the each of the decomposition components, the forward reaction rates for decomposition for the each of the solid decomposition products, and the backward reaction rates for decomposition for the each of the solid decomposition products, and by using the tar-cracking stoichiometric coefficients and the decomposition product stoichiometric coefficients, and using the rate of formation for the each separate solid species in the given cell and the time interval in order to determine a mass of the each separate solid species formed over the time interval in the given cell, such that the mass of the each separate solid species formed over the time interval in the given cell is determined for at least fixed carbon, volatile matter, ash, moisture content, decomposition components, and decomposition products,
e) determining a rate of consumption for each separate solid species in the given cell by using applicable solid consumption reaction rates for the each separate solid species, where the applicable solid consumption reaction rates for the each separate solid species describe reactions which results in consumption of the each separate solid species, and where the applicable solid formation consumption rates are comprised of one or more of the forward reaction rate for volatile matter, the reaction rate for tar-cracking, the forward reaction rates for decomposition for the each of the decomposition components, the backward reaction rates for decomposition for the each of the decomposition components, the forward reaction rates for decomposition for the each of the solid decomposition products, and the backward reaction rates for decomposition for the each of the solid decomposition products, and by using the tar-cracking stoichiometric coefficients and the decomposition product stoichiometric coefficients, and using the rate of consumption for the each separate solid species in the given cell and the time interval in order to determine a mass of the each separate solid species consumed over the time interval in the given cell, such that the mass of the each separate solid species consumed over the time interval in the given cell is determined for at least fixed carbon, volatile matter, ash, moisture content, decomposition components, and decomposition products,
f) determining the resulting mass change for each separate solid species based on the difference between the mass of the each separate solid species formed and the mass of the each separate solid species consumed over the time interval in the given cell, such that the resulting mass change for each separate solid species describes a mass change for at least fixed carbon, volatile matter, moisture, ash, decomposition components, and solid decomposition products in the solid phase over the time interval for the given cell,
g) determining the mass transferred between gas and solid phases of the given cell by summing the resulting mass change for each separate gas species in the given cell and summing the resulting mass change for each separate solid species in the given cell, and establishing the mass transfer to the gas phase and the mass transfer to the solid phase based on the summations,
thereby determining rates of formation, rates of consumption, the resulting mass change for each separate solid species, the resulting mass change for each separate gas species in the given cell, the mass transfer to the gas phase, and the mass transfer to the solid phase in the given cell,
6) determining the gas phase heat and the solid phase heat in the given cell by,
a) determining the gas phase heat in the given cell, where the gas phase heat in the given cell is net heat added to the gas phase of the given cell as a result of reactions in the gas phase of the given cell, by using known heats of formation for each separate gas species in the given cell, the applicable gas formation reaction rates for the each separate gas species, the applicable gas consumption reactions for the each separate gas species, the applicable solid formation reaction rates for the each separate gas species, and the applicable solid consumption rates for the each separate gas species, and by using the mass composition of separate gas species and the mass composition of separate solid species,
b) determining the solid phase heat in the given cell, where the solid phase heat in the given cell is net heat added to the solid phase of the given cell as a result of reactions in the solid phase of the given cell, by using known heats of formation for each separate solid species in the given cell, the applicable gas formation reaction rates for the each separate solid species, the applicable gas consumption reactions for the each separate solid species, the applicable solid formation reaction rates for the each separate solid species, and the applicable solid consumption rates for the each separate solid species, and by using the mass composition of separate gas species and the mass composition of separate solid species,
thereby determining the gas phase heat and the solid phase heat in the given cell,
7) assigning at least the gas phase heat, the solid phase heat, the resulting mass change for each separate solid species, the resulting mass change for each separate gas species, the mass transfer to the gas phase, and the mass transfer to the solid phase to the one of the cells comprising each cell in the fixed grid of cells selected as the given cell; and
C) assigning a different one of the each cells in the fixed grid of cells as the given cell, and determining reaction rates for combustion, gasification, moisture release, volatile release, water gas shift, tar cracking, and decomposition reactions in the given cell, determining rates of formation, rates of consumption, resulting mass changes, and final mass compositions of gas and solid species, determining the gas phase heat and the solid phase heat in the given cell and the mass transferred between gas and solid phases of the given cell, until all of the each cells in the fixed grid of cells has been individually analyzed,
thereby using the coal chemistry module to determine for each cell in the fixed grid of cells, the gas phase heat, the solid phase heat, the resulting mass change for each separate solid species, the resulting mass change for each separate gas species, the mass transfer to the gas phase, and the mass transfer to the solid phase.

22. The method of claim 21 where the mass composition of separate gas species for the given cell, the mass composition of separate solid species for the given cell, the gas velocity for the given cell, the solid velocity for the given cell, the mass of gas phase for the given cell, the mass of solid phase for the given cell, the gas phase temperature for the given cell, and the solid phase temperature for the given cell is received by communication from a Eulerian-eulerian model simulating the two phase flow through the gasification reactor at the time point.

23. The method of claim 22 where the coal chemistry module communicates the gas phase heat, the solid phase heat, the resulting mass change for each separate solid species, the resulting mass change for each separate gas species, the mass transfer to the gas phase, and the mass transfer to the solid phase assigned to each cell in the fixed grid of cells to the Eulerian-eulerian model simulating the two phase flow through the gasification reactor at the time point.

24. The method of claim 23 where the Eulerian-eulerian model and the coal chemistry module iteratively communicate to mathematically converge to within a desired result at the time point and over the time interval by,
A) using the Eulerian-eulerian model to solve an energy equation for the solid phase, an energy equation for the gas phase, a species balance equation for the solid phase, and a species balance equation for the gas phase in each cell in the fixed grid of cells, by utilizing the gas phase heat, the solid phase heat, the resulting mass change for each separate solid species, the resulting mass change for each separate gas species, the mass transfer to the gas phase, and the mass transfer to the solid phase assigned to each cell in the fixed grid of cells by the coal chemistry module and communicated from the coal chemistry module to the Eulerian-eulerian model, in order to determine an E-E solid phase temperature in each cell in the fixed grid of cells and an E-E gas phase temperature in each cell in the fixed grid of cells,
B) using the Eulerian-eulerian model to solve a momentum equation for the solid phase, a momentum equation for the gas phase, a continuity equation for the solid phase, and a continuity equation for the gas phase in each cell in the fixed grid of cells by using the E-E solid phase temperature in each cell in the fixed grid of cells and the E-E gas phase temperature in each cell in the fixed grid of cells, in order to determine an E-E mass composition of separate gas species for each cell in the fixed grid of cells, an E-E mass composition of separate solid species for each cell in the fixed grid of cells, an E-E gas velocity for each cell in the fixed grid of cells, an E-E solid velocity for each cell in the fixed grid of cells, an E-E mass of gas phase for each cell in the fixed grid of cells, an E-E mass of solid phase for each cell in the fixed grid of cells, an E-E gas phase temperature for each cell in the fixed grid of cells, and an E-E solid phase temperature for each cell in the fixed grid of cells,
C) utilizing the coal chemistry module and communicating from the Eulerian-eulerian model, when the coal chemistry module selects a given cell, the E-E mass composition of separate gas species for the each cell in the fixed grid of cells corresponding to the given cell, the E-E mass composition of separate solid species for the each cell in the fixed grid of cells corresponding to the given cell, the E-E gas velocity for the each cell in the fixed grid of cells corresponding to the given cell, the E-E solid velocity for the each cell in the fixed grid of cells corresponding to the given cell, the E-E mass of gas phase for the each cell in the fixed grid of cells corresponding to the given cell, the E-E mass of solid phase for the each cell in the fixed grid of cells corresponding to the given cell, the E-E gas phase temperature for the each cell in the fixed grid of cells corresponding to the given cell, and the E-E solid phase temperature for the each cell in the fixed grid of cells corresponding to the given cell, thereby providing the mass composition of separate gas species for the given cell, the mass composition of separate solid species for the given cell, the gas velocity for the given cell, the solid velocity for the given cell, the mass of gas phase for the given cell, the mass of solid phase for the given cell, the gas phase temperature for the given cell, and the solid phase temperature for the given cell to the coal chemistry module from the Eulerian-eulerian model,
D) returning to the step of using the Eulerian-eulerian model to solve an energy equation for the solid phase, an energy equation for the gas phase, a species balance equation for the solid phase, and a species balance equation for the gas phase in each cell in the fixed grid of cells, until the momentum equation for the solid phase, the momentum equation for the gas phase, the continuity equation for the solid phase, the continuity equation for the gas phase, the energy equation for the solid phase, the energy equation for the gas phase, the species balance equation for the solid phase, and the species balance equation for the gas phase mathematically converge to within the desired result at the time point and over the time interval.

25. The method of claim 24 where the Eulerian-eulerian model and the coal chemistry module iteratively communicate to mathematically converge to within a desired result at a plurality of consecutive time points and where, at each time point in the plurality of time points having an immediately chronologically preceding time point, the initial iteration is conducted using the E-E mass composition of separate gas species for the each cell in the fixed grid of cells, the E-E mass composition of separate solid species for the each cell in the fixed grid of cells, the E-E gas velocity for the each cell in the fixed grid of cells, the E-E solid velocity for the each cell in the fixed grid of cells, the E-E mass of gas phase for the each cell in the fixed grid of cells, the E-E mass of solid phase for the each cell in the fixed grid of cells, the E-E gas phase temperature for the each cell in the fixed grid of cells, and the E-E solid phase temperature for the each cell in the fixed grid of cells determined for the immediately chronologically preceding time point when the momentum equation for the solid phase, the momentum equation for the gas phase, the continuity equation for the solid phase, the continuity equation for the gas phase, the energy equation for the solid phase, the energy equation for the gas phase, the species balance equation for the solid phase, and the species balance equation for the gas phase mathematically converged to within the desired result at the immediately chronologically preceding time point, such that for the each time point in the plurality of time points having an immediately chronologically preceding time point, a portion of initial conditions is provided by the immediately chronologically preceding time point.

26. The method of claim 21 where the devolatization products and the tar-cracking products are further comprised of C₂H₄, C₂H₆, C₃H₈, C₆H₆, H₂S, and NH₃, and where the mass composition of separate gas species at the time point further includes a mass composition of at least C₂H₄, C₂H₆, C₃H₈, C₆H₆, H₂S, and NH₃.

27. The method of claim 21 where the decomposition components are comprised of CaCO₃ and CaMg(CO₃)₂, and where the decomposition products are comprised of CaO and MgO.

28. The method of claim 21 where the combustible gas species are comprised of CO, H₂, tar, and CH₄.

29. The method of claim 21 where the reaction rate for moisture release, the forward reaction rate for volatile release, and the backward reaction rate for volatile release are set to zero if the mass of volatile matter in the given cell is less than a predetermined value, and where the combustion reaction rate for each combustible gas species is set to zero if the partial pressure of the each combustible species is less than a predetermined value.

30. The method of claim 25 where iteratively utilizing a Eulerian-eulerian model and a coal chemistry module is interrupted if mathematical convergence to within a desired result has not occurred following a predetermined number of iterations.

31. A method of simulating the gasification of coal in a coal gasification reactor, comprising:
A) characterizing volatile matter, tar, and decomposition components in the coal using known or experimentally determined data, and determining stoichiometric coefficients for devolatization, tar-cracking, and decomposition components of the coal, and partitioning at least some portion of the coal gasification reactor by,
1) determining a composition of volatile matter in the coal where the composition of volatile matter is based on proximate and ultimate analysis of the coal, and determining devolatization products based on the composition of volatile matter, where the devolitization products are known or experimentally determined, and determining devolitization stoichiometric coefficients based on the devolitization products, where the devolitization products include at least tar, CO, CO₂, CH₄, H₂, and H₂O,
2) determining a composition of tar in the coal and determining tar-cracking products based on the composition of tar, where the composition of tar and the tar-cracking products are known or experimentally determined, and determining tar-cracking stoichiometric coefficients based on the tar-cracking products, where the tar-cracking products include at least C, CO, CO₂, CH₄, H₂, and H₂O,
3) determining a composition of decomposition components in the coal, where the decomposition components are constituents in the coal which decompose into gaseous and solid products under the influence of temperature, and which are not categorized as volatile matter in the coal, tar in the coal, or ash in the coal, and determining decomposition products, where the decomposition products are gaseous decomposition products and solid decomposition products produced by the decomposition components under the influence of temperature, where the composition of decomposition components and the decomposition products are known or experimentally determined, and determining decomposition product stoichiometric coefficients based on the decomposition products;
4) partitioning at least some portion of the coal gasification reactor into a fixed grid of cells, where each cell in the fixed grid of cells is a three-dimensional volume, such that a total volume of the fixed grid of cells is equal to the at least some portion of the coal gasification reactor,
thereby characterizing volatile matter, tar, and decomposition components in the coal using known or experimentally determined data, and determining stoichiometric coefficients for devolatization, tar-cracking, and decomposition components of the coal, and partitioning at least some portion of the coal gasification reactor;
B) iteratively utilizing a Eulerian-eulerian model and a coal chemistry module to model a two-phase flow through a coal gasification reactor at a time point and over a time interval, where the Eulerian-eulerian model is a finite-volume technique conducted over the fixed grid of cells, and where the two phase flow is comprised of a solid phase and a gas phase where the solid phase is comprised of coal particles of the coal, in order to quantify at least a pressure, a temperature, a velocity, and a composition in each cell in the fixed grid of cells by,
1) setting up for initial iteration by assigning, to each cell in the fixed grid of cells, an assigned total pressure at the time point, an assigned gas phase temperature at the time point, and an assigned solid phase temperature at the time point, and by assigning, to each cell in the fixed grid of cells, an assigned mass composition of separate gas species at the time point, where the assigned mass composition of separate gas species at the time point includes a mass composition of at least O₂, CO, CO₂, CH₄, H₂, H₂O, N₂, and tar within the gas phase of each cell, such that each cell is assigned a separate but not necessarily unique assigned mass composition of separate gas species, and assigning, to each cell in the fixed grid of cells, an assigned mass composition of separate solid species at the time point, where the assigned mass composition of separate solid species at the time point includes a mass composition of at least fixed carbon, volatile matter, moisture, ash, decomposition components, and solid decomposition products within the solid phase of each cell, such that each cell is assigned a separate but not necessarily unique assigned mass composition of separate solid species,
2) solving momentum and continuity equations with the Eulerian-eulerian model using the assigned mass composition of separate gas species at the time point and the assigned mass composition of separate solid species at the time point, such that the Eulerian-eulerian model solves a momentum equation for the solid phase, a momentum equation for the gas phase, a continuity equation for the solid phase, and a continuity equation for the gas phase, and provides at least a total pressure in each cell in the fixed grid of cells, a gas velocity in each cell in the fixed grid of cells, a solid velocity in each cell in the fixed grid of cells, a mass of gas phase in each cell in the fixed grid of cells, and a mass of solid phase in each cell in the fixed grid of cells, where the Eulerian-eulerian model utilizes variables based on a solid phase temperature in each cell in the fixed grid of cells to solve the momentum equation for the solid phase and the continuity equation for the solid phase, and where the Eulerian-eulerian model utilizes variables based on a gas phase temperature in each cell in the fixed grid of cells to solve the momentum equation for the gas phase and the continuity equation for the gas phase, and where for a first iteration of iteratively utilizing the Eulerian-eulerian model and the coal chemistry module at the time point, the solving momentum and continuity equations with the Eulerian-eulerian model is conducted using the assigned total pressure at the time point, the assigned gas phase temperature at the time point, and the assigned solid phase temperature at the time point,
3) utilizing the coal chemistry module to model the changes to the gas phase and the solid phase in each cell in the fixed grid of cells over the time interval, where the coal chemistry module represents the gas phase in each cell in the fixed grid of cells as the assigned mass composition of separate gas species at the time point, and where the coal chemistry module represents the solid phase in each cell in the fixed grid of cells as the assigned mass composition of separate solid species at the time point, and individually analyzing each cell in the fixed grid of cells by selecting a given cell, where the given cell is one of the cells comprising each cell in the fixed grid of cells, and analyzing the given cell by,
a) determining reaction rates for combustion, gasification, moisture release, volatile release, water gas shift, tar cracking, and decomposition reactions in the given cell by,
i) determining, for each separate gas species in the assigned mass composition of separate gas species in the given cell, a partial pressure, by using the total pressure in the given cell, the mass of gas phase in the given cell, and the assigned mass composition of separate gas species in the given cell, such that at least an O₂ partial pressure, a CO partial pressure, a CO₂ partial pressure, a CH₄ partial pressure, an H₂ partial pressure, an H₂O partial pressure, an N₂ partial pressure, and a tar partial pressure in the given cell is determined for the given cell,
ii) determining combustible gas species in the given cell, where a combustible gas species is a gas species in the assigned mass composition of separate gas species expected to combust in the coal gasification reactor, and, if the O₂ partial pressure is greater than zero in the given cell, determining a combustion reaction rate for each combustible gas species, by using the gas phase temperature in the given cell and the assigned mass composition of separate gas species in the given cell with applicable reaction rate of combustion equations, such that at least a CO combustion rate, a CO₂ combustion rate, a CH₄ combustion rate, and an H₂ combustion rate is determined for the given cell,
iii) determining a combustion reaction rate for fixed carbon in the given cell if the O₂ partial pressure is greater than zero in the given cell, by determining a mass of fixed carbon in the given cell based on the assigned mass composition of separate solid species in the given cell, and by using the solid phase temperature in the given cell, the mass of fixed carbon in the given cell, the gas velocity for the given cell, and the solid velocity for the given cell with applicable reaction rate of combustion equations,
iv) determining reaction rates for gasification for the given cell by at least,
1) determining a forward reaction rate for steam gasification and a backward reaction rate for steam gasification in the given cell, where steam gasification refers to a reaction between the mass of fixed carbon in the given cell and H₂O in the given cell to produce CO and H₂ in the given cell, by using the gas phase temperature in the given cell and the mass of fixed carbon in the given cell and the H₂O partial pressure, the H₂ partial pressure, and the CO partial pressure in the given cell with applicable steam gasification reaction rate equations,
2) determining a forward reaction rate for CO₂ gasification and a backward reaction rate for CO₂ gasification in the given cell, where CO₂ gasification refers to a reaction between the mass of fixed carbon in the given cell and CO₂ in the given cell to produce CO in the given cell, by using the gas phase temperature in the given cell and the mass of fixed carbon in the given cell and the CO₂ partial pressure and the CO partial pressure in the given cell with applicable CO₂ gasification reaction rate equations,
3) determining a forward reaction rate for methanation and a backward reaction rate for methanation in the given cell, where methanation refers to a reaction between the mass of fixed carbon in the given cell and H₂ in the given cell to produce CH₄ in the given cell, by using the gas phase temperature in the given cell and the mass of fixed carbon in the given cell and the H₂ partial pressure and the CH₄ partial pressure in the given cell with applicable methanation reaction rate equations,
thereby determining the reaction rates for gasification for the given cell,
v) determining a reaction rate for moisture release in the given cell, where moisture release refers to the release of H₂O from the solid species moisture in the given cell to the gas species H₂O in the given cell, by determining a mass of moisture in the given cell based on the assigned mass composition of separate solid species in the given cell, and by using the solid phase temperature in the given cell and the mass of moisture in the given cell with applicable moisture release reaction rate equations,
vi) determining a forward reaction rate for volatile release and a backward reaction rate for volatile release in the given cell, where volatile release refers to the release of the devolitization products from the solid species volatile matter in the given cell to the gas species corresponding to each of the devolitization products in the given cell, by determining a mass of volatile matter in the given cell based on the assigned mass composition of separate solid species in the given cell, and by using the solid phase temperature in the given cell and the mass of volatile matter in the given cell with applicable volatile release reaction rate equations,
vii) determining a forward reaction rate for water gas shift and a backward reaction rate for water gas shift in the given cell, where water gas shift refers to a reaction between the gas species CO in the given cell and the gas species H₂O in the given cell to produce the gas species CO₂ in the given cell and the gas species H₂ in the given cell, by using the gas phase temperature in the given cell, the total pressure in the given cell, and the CO partial pressure, the H₂O partial pressure, the CO₂ partial pressure, and the H₂ partial pressure in the given cell with applicable water gas shift reaction rate equations,
viii) determining a reaction rate for tar-cracking in the given cell, where tar-cracking refers to the gas species tar in the given cell producing the tar-cracking products in the given cell, by using the gas phase temperature in the given cell and the tar partial pressure in the given cell with applicable tar-cracking reaction rate equations,
ix) determining a forward reaction rate for decomposition and a backward reaction rate for decomposition in the given cell for each of the decomposition components and each of the solid decomposition products, where decomposition refers a reaction between the decomposition components and the solid decomposition products from the influence of temperature on the each of the decomposition components and the each of the solid decomposition products, by determining a mass for the each of the decomposition components and a mass for the each of the solid decomposition products in the given cell based on the assigned mass composition of separate solid species in the given cell, and by using the solid phase temperature in the given cell, the mass for the each of the decomposition components in the given cell, and the mass for the each of the solid decomposition products in the given cell with applicable decomposition reaction rate equations,
thereby determining reaction rates for combustion, gasification, moisture release, volatile release, water gas shift, tar cracking, and decomposition reactions in the given cell,
b) determining rates of formation, rates of consumption, resulting mass changes, final mass compositions of gas and solid species, and mass transferred between gas and solid phases in the given cell by,
i) determining a rate of formation for each separate gas species in the given cell by using applicable gas formation reaction rates for the each separate gas species, where the applicable gas formation reaction rates for the each separate gas species describe reactions which results in formation of the each separate gas species, and where the applicable gas formation reaction rates are comprised of one or more of the combustion reaction rates for each combustible gas species, the combustion reaction rate for the fixed carbon, the forward reaction rate for steam gasification, the backward reaction rate for steam gasification, the forward reaction rate for CO₂ gasification, the backward reaction rate for CO₂ gasification, the forward reaction rate for methanation, the backward reaction rate for methanation, the reaction rate for moisture release, the forward reaction rate for volatile matter, the forward reaction rate for water gas shift, the backward reaction rate for water gas shift, the reaction rate for tar-cracking, the forward reaction rates for decomposition for the each of the decomposition components, and by using the devolitization stoichiometric coefficients, the tar-cracking stoichiometric coefficients, and the decomposition product stoichiometric coefficients that reflect formation of the each separate gas species in the given cell, and using the rate of formation for the each separate gas species in the given cell and the time interval in order to determine a mass of the each separate gas species formed over the time interval in the given cell, such that the mass of the each separate gas species formed over the time interval in the given cell is determined for at least O₂, CO, CO₂, CH₄, H₂, H₂O, N₂, and tar,
ii) determining a rate of consumption for the each separate gas species in the given cell by using applicable gas consumption reaction rates for the each separate gas species, where the applicable gas consumption reaction rates for the each separate gas species describe reactions which results in consumption of the each separate gas species, and where the applicable gas consumption reaction rates are comprised of one or more of the combustion reaction rates for each combustible gas species, the combustion reaction rate for the fixed carbon, the forward reaction rate for steam gasification, the backward reaction rate for steam gasification, the forward reaction rate for CO₂ gasification, the backward reaction rate for CO₂ gasification, the forward reaction rate for methanation, the backward reaction rate for methanation, the backward reaction rate for volatile matter, the forward reaction rate for water gas shift, the backward reaction rate for water gas shift, the backward reaction rates for decomposition for the each of the solid decomposition products, and by using the tar-cracking stoichiometric coefficients when the each separate gas species in the given cell is tar, and using the rate of consumption for the each separate gas species in the given cell and the time interval in order to determine a mass of the each separate gas species consumed over the time interval in the given cell, such that the mass of the each separate gas species consumed over the time interval in the given cell is determined for at least O₂, CO, CO₂, CH₄, H₂, H₂O, N₂, and tar,
iii) determining a resulting mass change for each separate gas species based on the difference between the mass of the each separate gas species formed and the mass of the each separate gas species consumed over the time interval in the given cell, and establishing a final mass composition of separate gas species for the given cell, where the final mass composition of separate gas species for the given cell includes a mass composition of at least O₂, CO, CO₂, CH₄, H₂, H₂O, N₂, and tar within the gas phase of the given cell, and where the final mass composition of separate gas species for the given cell is based on the assigned mass composition of separate gas species at the time point and the resulting mass change for each separate gas species in the given cell,
iv) determining a rate of formation for each separate solid species in the given cell by using applicable solid formation reaction rates for the each separate solid species, where the applicable solid formation reaction rates for the each separate solid species describe reactions which results in formation of the each separate solid species, and where the applicable solid formation reaction rates are comprised of one or more of the backward reaction rate for volatile matter, the reaction rate for tar-cracking, the forward reaction rates for decomposition for the each of the decomposition components, the backward reaction rates for decomposition for the each of the decomposition components, the forward reaction rates for decomposition for the each of the solid decomposition products, and the backward reaction rates for decomposition for the each of the solid decomposition products, and by using the tar-cracking stoichiometric coefficients and the decomposition product stoichiometric coefficients, and using the rate of formation for the each separate solid species in the given cell and the time interval in order to determine a mass of the each separate solid species formed over the time interval in the given cell, such that the mass of the each separate solid species formed over the time interval in the given cell is determined for at least fixed carbon, volatile matter, ash, moisture content, decomposition components, and decomposition products,
v) determining a rate of consumption for each separate solid species in the given cell by using applicable solid consumption reaction rates for the each separate solid species, where the applicable solid consumption reaction rates for the each separate solid species describe reactions which results in consumption of the each separate solid species, and where the applicable solid formation consumption rates are comprised of one or more of the forward reaction rate for volatile matter, the reaction rate for tar-cracking, the forward reaction rates for decomposition for the each of the decomposition components, the backward reaction rates for decomposition for the each of the decomposition components, the forward reaction rates for decomposition for the each of the solid decomposition products, and the backward reaction rates for decomposition for the each of the solid decomposition products, and by using the tar-cracking stoichiometric coefficients and the decomposition product stoichiometric coefficients, and using the rate of consumption for the each separate solid species in the given cell and the time interval in order to determine a mass of the each separate solid species consumed over the time interval in the given cell, such that the mass of the each separate solid species consumed over the time interval in the given cell is determined for at least fixed carbon, volatile matter, ash, moisture content, decomposition components, and decomposition products,
vi) determining a resulting mass change for each separate solid species based on the difference between the mass of the each separate solid species formed and the mass of the each separate solid species consumed over the time interval in the given cell, and establishing a final mass composition of separate solid species for the given cell, where the final mass composition of separate solid species for the given cell includes a mass composition of at least fixed carbon, volatile matter, moisture, ash, decomposition components, and solid decomposition products, and where the final mass composition of separate solid species for the given cell is based on the assigned mass composition of separate solid species at the time point and the resulting mass change for each separate solid species in the given cell,
iii) determining the mass transferred between gas and solid phases of the given cell by summing the resulting mass change for each separate gas species in the given cell and summing the resulting mass change for each separate solid species in the given cell, and establishing a mass transfer to the gas phase and a mass transfer to the solid phase based on the summations,
thereby determining rates of formation, rates of consumption, resulting mass changes, final mass compositions of gas and solid species, and mass transferred between gas and solid phases in the given cell,
c) determining a gas phase heat and a solid phase heat in the given cell by,
i) determining the gas phase heat in the given cell, where the gas phase heat in the given cell is net heat added to the gas phase of the given cell as a result of reactions in the gas phase of the given cell, by using known heats of formation for each separate gas species in the given cell, the applicable gas formation reaction rates for the each separate gas species, the applicable gas consumption reactions for the each separate gas species, the applicable solid formation reaction rates for the each separate gas species, and the applicable solid consumption rates for the each separate gas species, and by using the assigned mass composition of separate gas species and the assigned mass composition of separate solid species,
ii) determining the solid phase heat in the given cell, where the solid phase heat in the given cell is net heat added to the solid phase of the given cell as a result of reactions in the solid phase of the given cell, by using known heats of formation for each separate solid species in the given cell, the applicable gas formation reaction rates for the each separate solid species, the applicable gas consumption reactions for the each separate solid species, the applicable solid formation reaction rates for the each separate solid species, and the applicable solid consumption rates for the each separate solid species, and by using the assigned mass composition of separate gas species and the assigned mass composition of separate solid species,
thereby determining the gas phase heat and the solid phase heat in the given cell,
d) assigning at least the gas phase heat in the given cell, the solid phase heat in the given cell, the resulting mass change for each separate solid species in the given cell, the resulting mass change for each separate gas species in the given cell, the mass transfer to the gas phase in the given cell, and the mass transfer to the solid phase in the given cell to the one of the cells comprising each cell in the fixed grid of cells selected as the given cell,
4) assigning a different one of the each cells in the fixed grid of cells as the given cell, and determining reaction rates for combustion, gasification, moisture release, volatile release, water gas shift, tar cracking, and decomposition reactions in the given cell, determining rates of formation, rates of consumption, resulting mass changes, and final mass compositions of gas and solid species, determining the gas phase heat and the solid phase heat in the given cell and the mass transferred between gas and solid phases of the given cell, until all of the each cells in the fixed grid of cells has been individually analyzed, thereby utilizing the coal chemistry module to model the changes to the coal particles in each cell in the fixed grid of cells at the discrete time,
5) utilizing the Eulerian-eulerian model to solve an energy equation for the solid phase, an energy equation for the gas phase, a species balance equation for the solid phase, and a species balance equation for the gas phase using at least the gas phase heat, the solid phase heat, the resulting mass change for each separate solid species, the resulting mass change for each separate gas species, the mass transfer to the gas phase, and the mass transfer to the solid phase that was assigned to each cell in the fixed grid of cells in order to determine at least the solid phase temperature in each cell in the fixed grid of cells and the gas phase temperature in each cell in the fixed grid of cells; and
6) returning to the solving momentum and continuity equations with the Eulerian-eulerian model step and updating terms in the momentum equation for the solid phase, the momentum equation for the gas phase, the continuity equation for the solid phase, and the continuity equation for the gas phase based on solving the energy equation for the solid phase, the energy equation for the gas phase, the species balance equation for the solid phase, and the species balance equation for the gas phase, until the momentum equation for the solid phase, the momentum equation for the gas phase, the continuity equation for the solid phase, the continuity equation for the gas phase, the energy equation for the solid phase, the energy equation for the gas phase, the species balance equation for the solid phase, and the species balance equation for the gas phase mathematically converge to within a desired result,
thereby iteratively utilizing the Eulerian-eulerian model and the coal chemistry module to model a two-phase flow through a coal gasification reactor at a time point and over a time interval, in order to quantify at least a pressure, a temperature, a velocity, and a composition in each cell in the fixed grid of cells,
thereby providing a method of simulating the gasification of coal in a coal gasification reactor.

32. The method of claim 31 where modeling two-phase coal gasification in the coal gasification reactor is conducted at a plurality of consecutive time points where, at an earliest chronological time point, the assigned mass composition of the gas phase at the time point, the assigned mass composition of the solid phase at the time point, the assigned total pressure at the time point, the assigned gas phase temperature at the time point, and the assigned solid phase temperature at the time point are assumed quantities, and where, at each chronologically succeeding time point having an immediately chronologically preceding time point, and for each cell in the fixed grid of cells,
a) the assigned mass composition of the gas phase at the time point is the final mass composition of separate gas species in the each cell following mathematical convergence to a desired result for the immediately chronologically preceding time point,
b) the assigned mass composition of the solid phase at the time point is the final mass composition of separate solid species in the each cell following mathematical convergence to a desired result for the immediately chronologically preceding time point,
c) the assigned total pressure at the time point is the total pressure in the each cell following mathematical convergence to a desired result for the immediately chronologically preceding time point,
d) the assigned gas phase temperature at the time point is the gas phase temperature in the each cell following mathematical convergence to a desired result for the immediately chronologically preceding time point,
e) the assigned solid phase temperature at the time point is the solid phase temperature in the each cell following mathematical convergence to a desired result for the immediately chronologically preceding time point,
such that each time point in the plurality of consecutive time points except the earliest chronological time point utilizes initial conditions provided by convergence at the immediately chronologically preceding time point.

33. The method of claim 31 where the devolatization products are further comprised of C₂H₄, C₂H₆, C₃H₈, C₆H₆, H₂S, and NH₃, and where the assigned mass composition of separate gas species at the time point further includes a mass composition of at least C₂H₄, C₂H₆, C₃H₈, C₆H₆, H₂S, and NH₃.

34. The method of claim 31, where the tar-cracking products are further comprised of C₂H₄, C₂H₆, C₃H₈, C₆H₆, H₂S, and NH₃, and where the assigned mass composition of separate gas species at the time point further includes a mass composition of at least C₂H₄, C₂H₆, C₃H₈, C₆H₆, H₂S, and NH₃.

35. The method of claim 31 where the decomposition components are comprised of CaCO₃ and CaMg(CO₃)₂, and where the decomposition products are comprised of CaO and MgO.

36. The method of claim 31 where the combustible gas species are comprised of CO, H₂, tar, and CH₄.

37. The method of claim 31 where the combustion reaction rate for the fixed carbon is based on a mass transfer coefficient of the fixed carbon, a void fraction of the ash layer, and a film resistance based on the Sherwood number.

38. The method of claim 31 where the reaction rate for moisture release, the forward reaction rate for volatile release, and the backward reaction rate for volatile release are set to zero if the mass of volatile matter in the given cell is less than a predetermined value.

39. The method of claim 31 where the combustion reaction rate for each combustible gas species is set to zero if the partial pressure of the each combustible species is less than a predetermined value.

40. The method of claim 31 where iteratively utilizing a Eulerian-eulerian model and a coal chemistry module is interrupted if mathematical convergence to within a desired result has not occurred following a predetermined number of iterations.
